(19) United States
(12) Patent Application Publication
(10) Pub. No.: US 2009/0260948 A1
(43) Pub. Date: Oct. 22, 2009

(54) Money handling machine

(75) Inventor: Yasuhiro Matsumoto, Himeji-shi (JP)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(73) Assignee: GLORY LTD., a corporation of Japan, Himeji-shi (JP)

(21) Appl. No.: 12/148,764

(22) Filed: Apr. 22, 2008

(51) Int. Cl. G07F 9/00

(52) U.S. Cl. 194/302

(57) ABSTRACT

The present invention provides a money handling machine configured to selectively perform one of the following three processes: (A) a mass delivery process for transporting money inserted in a casing through a money insertion opening, to a money holding unit, by using a transport unit, and then transferring the money held in the money holding unit, into a money storage unit; (B) a process, in a mode with a delivery process, for performing a depositing process for depositing the money inserted in the casing through the money insertion opening, into the money storage unit, together with the delivery process for delivering the money stored in each recycling-style money storage unit, to the money storage unit; and (C) a process, in a mode without the delivery process, for performing the depositing process for depositing the money inserted in the casing through the money insertion opening, into the money storage unit, independently of the delivery process for delivering the money stored in each recycling-style money storage unit, to the money storage unit.

### FIELD OF THE INVENTION

The present invention relates to a money handling machine adapted for performing various processes for money including coins and/or banknotes.

### BACKGROUND ART

In the past, as the money handling machine configured to store the money including coins and/or banknotes in a casing, those disclosed in, for example, JP6-266963A, JP2001-67526A, or JP2002-312821A are known.

In such a conventional money handling machine, a money storage unit provided in the casing and adapted for storing the money therein, a money insertion opening configured for inserting the money into the casing, a transport unit adapted for transporting the money inserted in the casing through the money insertion opening, a discriminating unit provided with the transport unit and adapted for discriminating the money transported by the transport unit, a money return opening connected with the transport unit and configured for returning the money transferred from the transport unit, to the exterior of the casing, and a money holding unit connected with the transport unit and adapted for temporarily holding the money that will be stored in the money storage unit are provided, respectively. With control of the transport unit and/or money holding unit due to a control unit, the money inserted into the casing through the money insertion opening can be transported in the casing by the transport unit, and finally the money will be stored in the money storage unit.

### SUMMARY OF THE INVENTION

However, in the conventional money handling machine, the control unit can perform only one kind of handling process, such as a depositing process, in which the money inserted into the casing through the money insertion opening is first transported to the money holding unit by the transport unit, and the money held in the money holding unit is then transferred into the money storage unit. Namely, such a control unit cannot perform plural kinds of handling processes while switching them from one to another. Therefore, today, there is a demand for a control method for controlling the money handling machine that can selectively perform such plural kinds of handling processes.

The present invention was made in light of the above challenge, and therefore it is an object of this invention to provide the money handling machine that can selectively perform various kinds of handling processes for handling the coins and/or banknotes.

One aspect of the present invention is a money handling machine adapted for handling money, comprising: a casing; a money storage unit provided in the casing and configured for storing the money therein; a money insertion opening configured for inserting the money into the casing; a transport unit provided in the casing and adapted for transporting the money inserted in the casing through the money insertion opening; a discriminating unit provided with the transport unit and adapted for discriminating the money transported by the transport unit; a money return opening connected with the transport unit and configured for returning the money transferred from the transport unit, to the exterior of the casing; recycling-style money storage units provided in the casing, in a plural number, corresponding to each denomination of money, each recycling-style money storage unit being connected with the transport unit as well as configured for allowing the money, corresponding to each denomination of money, to be stored therein and fed out therefrom; a money holding unit connected with the transport unit and adapted for temporarily holding the money that will be stored in the money storage unit; and a control unit adapted for controlling the transport unit, recycling-style money storage units and money holding unit, respectively; wherein the control unit is configured to selectively perform one of the following three processes: (A) a mass delivery process for transporting the money inserted in the casing through the money insertion opening, to the money holding unit, by using the transport unit, and then transferring the money held in the money holding unit, into the money storage unit; (B) a process, in a mode with a delivery process, for performing a depositing process for depositing the money inserted in the casing through the money insertion opening, into the money storage unit, together with the delivery process for delivering the money stored in each recycling-style money storage unit, into the money storage unit; and (C) a process, in a mode without the delivery process, for performing the depositing process for depositing the money inserted in the casing through the money insertion opening, into the money storage unit, independently of the delivery process for delivering the money stored in each recycling-style money storage unit, into the money storage unit.

Another aspect of the present invention is a money handling machine adapted for handling money, comprising: a casing; a money storage unit provided in the casing and configured for storing the money therein; a money insertion opening configured for inserting the money into the casing; a transport unit provided in the casing and adapted for transporting the money inserted in the casing through the money insertion opening; a discriminating unit provided with the transport unit and adapted for discriminating the money transported by the transport unit; a money return opening connected with the transport unit and configured for returning the money transferred from the transport unit, to the exterior of the casing; a money holding unit connected with the transport unit and configured for transferring the money transferred from the transport unit, to the money storage unit; and a control unit adapted for controlling the transport unit and money holding unit; wherein the control unit is configured to selectively perform one of the following two processes: (A) a delivery process for allowing the money inserted in the casing through the money insertion opening to be once held in the money holding unit, and then delivering the money held in the money holding unit, into the money storage unit; and (B) a counting process for counting the money inserted in the casing through the money insertion opening, by using the discriminating unit, and then returning the counted money to the exterior of the casing.

In the various money handling machines as described above, the term “depositing process” generally means a process for receiving the money into the money handling machine or the like. Strictly speaking, however, this term is intended herein to express a situation that the money is deposited into the money handling machine. In addition, the term “delivery process” is intended herein to express a process for delivering the money in the money handling machine to a security company or the like from a store or shop. Accordingly, in the money handling machine as described above, the banknotes and/or coins once taken in the money handling machine and then stored in the money storage unit and those once stored in each recycling-style money storage unit and then stored in the money storage unit are all considered as ones delivered.

### BRIEF DESCRIPTION OF THE DRAWINGS

FIG. 1 is a perspective view showing the money handling machine in a first embodiment of the present invention.

FIG. 2 is a schematic view showing general construction of a banknote handling apparatus in the money handling machine shown in FIG. 1.

FIG. 3 is a schematic view showing general construction of a coin handling apparatus in the money handling machine shown in FIG. 1.

FIG. 4 is a control block diagram for the money handling machine shown in FIG. 1.

FIGS. 5A and 5B are illustrations respectively showing a series of operations for a complementing process in the banknote handling apparatus of the money handling machine shown in FIG. 1.

FIGS. 6A and 6B are illustrations respectively showing a series of operations for the complementing process in the coin handling apparatus of the money handling machine shown in FIG. 1.

FIGS. 7A to 7E are illustrations respectively showing a series of operations for a depositing process in the banknote handling apparatus of the money handling machine shown in FIG. 1.

FIGS. 8A to 8F are illustrations respectively showing a series of operations for the depositing process in the coin handling apparatus of the money handling machine shown in FIG. 1.

FIG. 9 is an illustration showing a series of operations for a disbursing process in the banknote handling apparatus of the money handling machine shown in FIG. 1.

FIG. 10 is an illustration showing a series of operations for the disbursing process in the coin handling apparatus of the money handling machine shown in FIG. 1.

FIGS. 11A and 11B are illustrations respectively showing a series of operations for a delivery process in the banknote handling apparatus of the money handling machine shown in FIG. 1.

FIGS. 12A and 12B are illustrations respectively showing a series of operations for the delivery process in the coin handling apparatus of the money handling machine shown in FIG. 1.

FIGS. 13A to 13C are illustrations respectively showing a series of operations for a mass delivery process in the banknote handling apparatus of the money handling machine shown in FIG. 1.

FIGS. 14A to 14C are illustrations respectively showing a series of operations for the mass delivery process in the coin handling apparatus of the money handling machine shown in FIG. 1.

FIGS. 15A to 15C are illustrations respectively showing a series of operations for an exchange from large denomination to small denomination process and an exchange from small denomination to large denomination process in the banknote handling apparatus of the money handling machine shown in FIG. 1.

FIGS. 16A to 16C are illustrations respectively showing a series of operations for the exchange from large denomination to small denomination process and the exchange from small denomination to large denomination process in the coin handling apparatus of the money handling machine shown in FIG. 1.

FIG. 17 is an illustration showing a series of operations for a checking process in the banknote handling apparatus of the money handling machine shown in FIG. 1.

FIGS. 18A and 18B are illustrations respectively showing a series of operations for the checking process in the coin handling apparatus of the money handling machine shown in FIG. 1.

FIGS. 19A and 19B are illustrations respectively showing a series of operations for a counting process in the banknote handling apparatus of the money handling machine shown in FIG. 1.

FIGS. 20A and 20B are illustrations respectively showing a series of operations for the counting process in the coin handling apparatus of the money handling machine shown in FIG. 1.

FIG. 21 is a perspective view showing the money handling machine in a second embodiment of the present invention.

FIG. 22 is a schematic view showing general construction of the banknote handling apparatus in the money handling machine shown in FIG. 21.

FIG. 23 is a schematic view showing general construction of the coin handling apparatus in the money handling machine shown in FIG. 21.

FIG. 24 is a control block diagram for the money handling machine shown in FIG. 21.

FIGS. 25A to 25C are illustrations respectively showing a series of operations for the delivery process in the banknote handling apparatus of the money handling machine shown in FIG. 21.

FIGS. 26A to 26C are illustrations respectively showing a series of operations for the delivery process in the coin handling apparatus of the money handling machine shown in FIG. 21.

FIGS. 27A and 27B are illustrations respectively showing a series of operations for the counting process in the banknote handling apparatus of the money handling machine shown in FIG. 21.

FIGS. 28A and 28B are illustrations respectively showing a series of operations for the counting process in the coin handling apparatus of the money handling machine shown in FIG. 21.

FIG. 29 is an illustration showing a series of operations for a foreign material returning process in the coin handling apparatus of the money handling machine shown in FIG. 21.

### DETAILED DESCRIPTION OF THE INVENTION

### First Embodiment

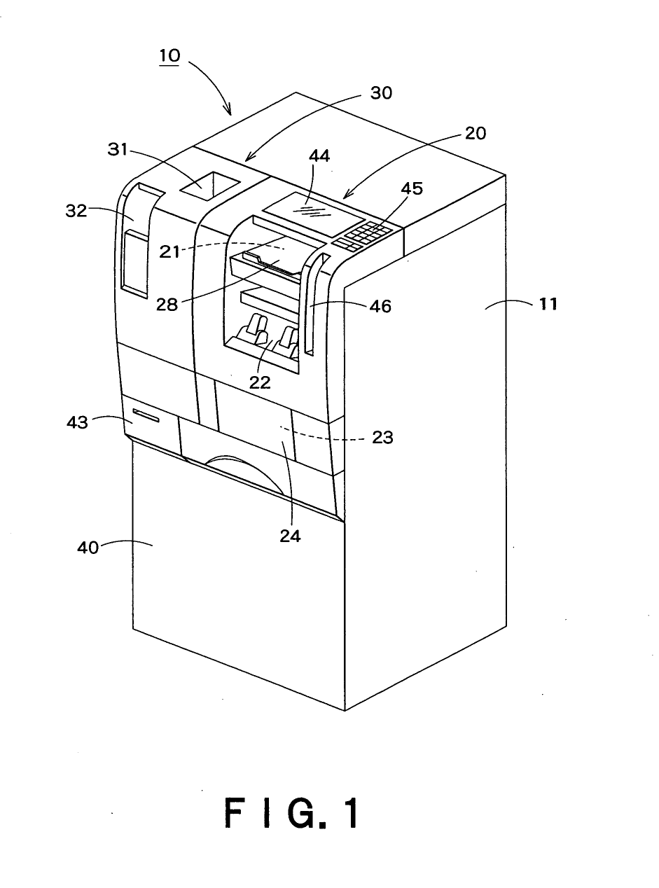

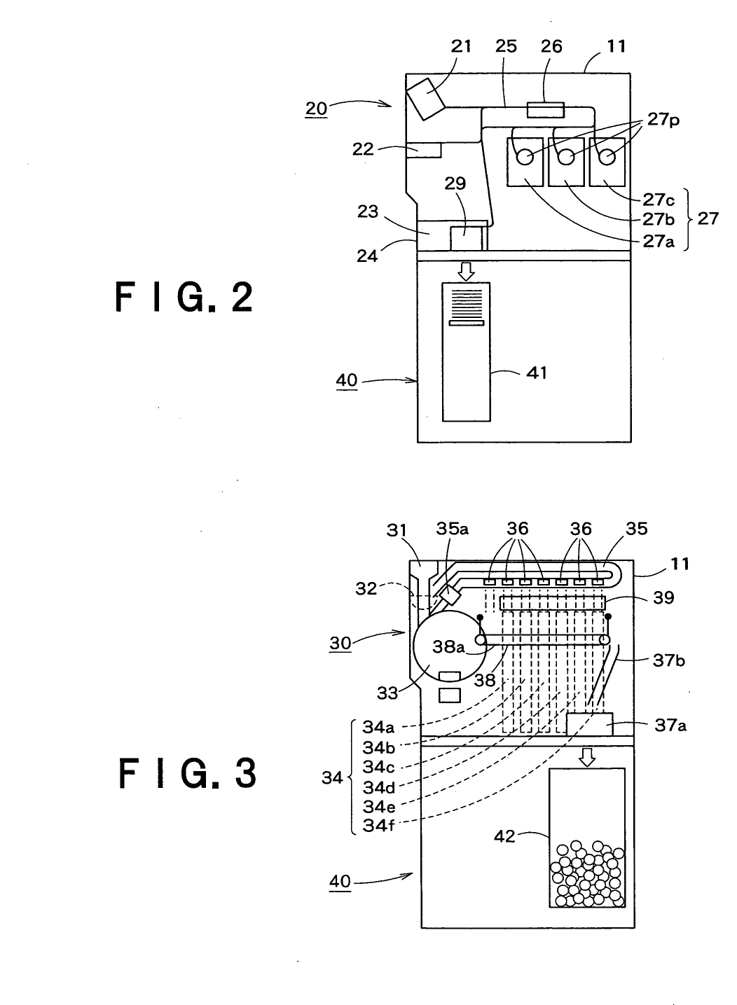

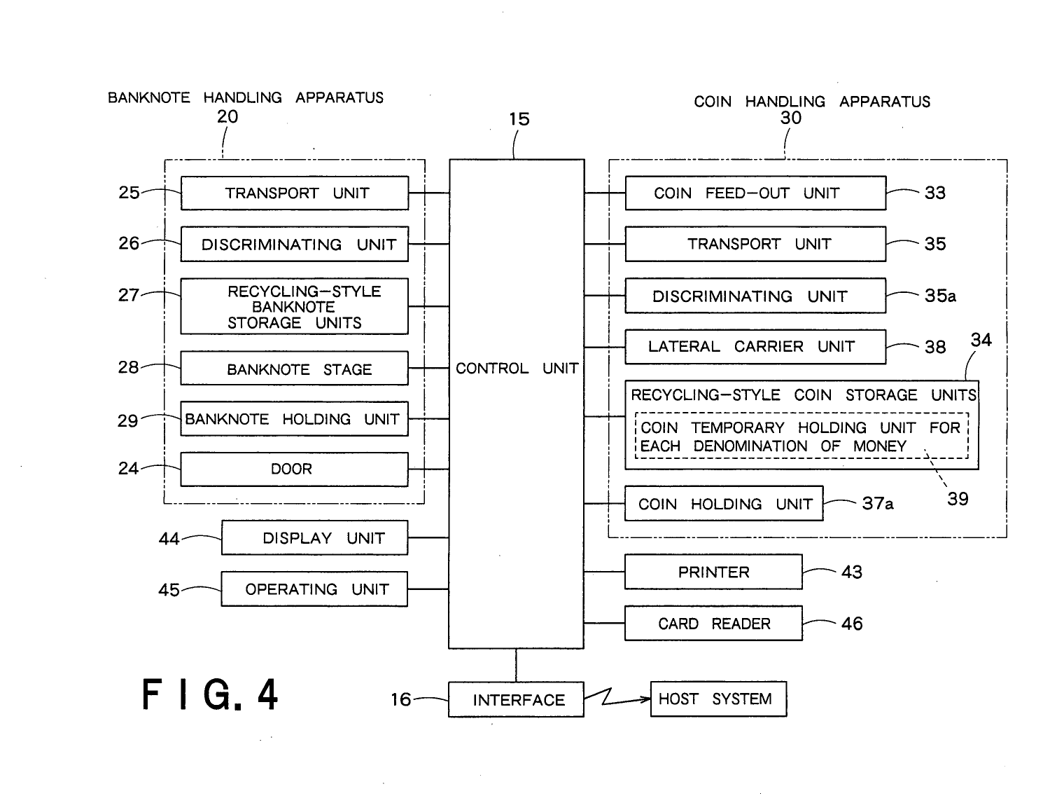

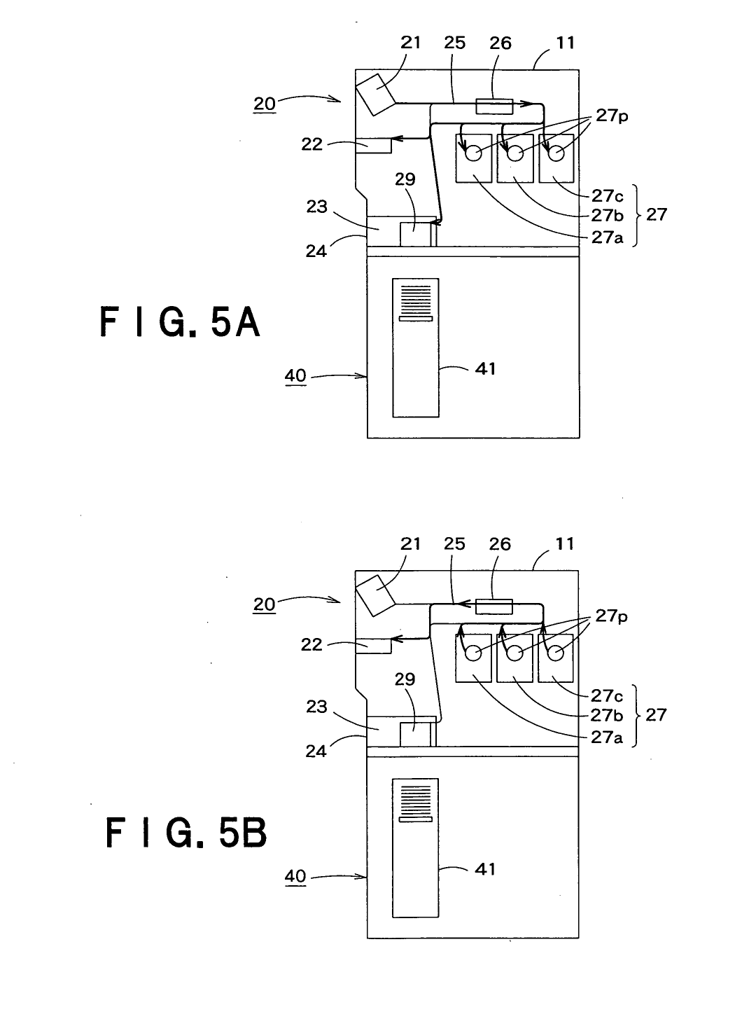

Hereinafter, the money handling machine of a first embodiment of the present invention will be described with reference to the drawings. The money handling machine related to this embodiment has functions for performing a complementing process, a depositing process, a disbursing process, a delivery process, a mass delivery process, an exchange from large denomination to small denomination process, an exchange from small denomination to large denomination process, a checking process, a counting process and the like, respectively, for the money including coins and banknotes. FIGS. 1 to 20 respectively show the first embodiment of the money handling machine according to the present invention. Of these drawings, FIG. 1 is a perspective view showing the money handling machine of the first embodiment of the present invention, FIG. 2 is a schematic view showing general construction of a banknote handling apparatus of the money handling machine shown in FIG. 1, and FIG. 3 is a schematic view showing general construction of a coin handling apparatus of the money handling machine shown in FIG. 1. FIG. 4 is a control block diagram for the money handling machine shown in FIG. 1. FIGS. 5 to 20 are illustrations respectively showing various processes in the banknote handling apparatus or coin handling apparatus of the money handling machine shown in FIG. 1.

As shown in FIG. 1, the money handling machine 10 includes a generally rectangular parallelepiped casing 11. In the casing 11, when seen in a front view, the banknote handling apparatus 20 located on the right side of the money handling machine 10 and the coin handling apparatus 30 located on the left side are provided side by side. In the casing 11 of the money handling machine 10 and below the banknote handling apparatus 20 and coin handling apparatus 30, a money storage unit 40 configured for storing therein the coins and/or banknotes is provided. Now, each component of the banknote handling apparatus 20, coin handling apparatus 30 and money storage unit 40 will be detailed.

First, the construction of the banknote handling apparatus 20 will be described with reference to FIGS. 1 and 2. As shown in FIGS. 1 and 2, the banknote handling apparatus 20 includes a banknote insertion opening 21 configured for taking the banknotes into the banknote handling apparatus 20, a banknote eject opening 22 configured for ejecting unfit banknotes, unidentifiable banknotes and the like, among the banknotes taken into the banknote handling apparatus 20, and a banknote return opening 23 configured for returning the banknotes, which are not allowed to be stored in the money storage unit 40, among those taken into the banknote handling apparatus 20, to the exterior of the banknote handling apparatus 20. In addition, as shown in FIG. 2, in the banknote handling apparatus 20, a transport unit 25 is provided, which is adapted for transporting the banknotes inserted through the banknote insertion opening 21, in the banknote handling apparatus 20.

The banknote insertion opening 21 is configured such that one sheet or multiple sheets of banknotes arranged in a bundle can be inserted through the opening, collectively, by an operator, in the transverse direction of the banknotes. As shown in FIG. 1, a banknote stage 28 is provided to the banknote insertion opening 21. The banknote stage 28 is configured such that the operator cannot insert the banknotes into the banknote insertion opening 21 when the banknote stage 28 is in an elevated position during a period of time for waiting, while the operator can insert the banknotes into the banknote insertion opening 21 when the banknote stage 28 is lowered during a period of time for handling the banknotes. As shown in FIG. 2, the banknote insertion opening 21 is connected with the transport unit 25, so that one sheet or multiple sheets of banknotes arranged in a bundle inserted through the banknote insertion opening 21 can be transported by the transport unit 25, one sheet for each operation (or one by one).

The banknote eject opening 22 is also connected with the transport unit 25 as shown in FIG. 2. Thus, the banknotes discriminated to be ejected, by a discriminating unit 26 which will be described later, among the banknotes taken into the banknote handling apparatus 20 through the banknote insertion opening 21, will be transferred from the transport unit 25 to the banknote eject opening 22. Consequently, the operator can take out the banknotes transferred to the banknote eject opening 22. The banknote eject opening 22 can also serve as a disbursing opening for disbursing changes and the like. A cover (not shown) is provided to the banknote eject opening 22. This cover is opened during the period of time for waiting, while closed during the period of time for handling the banknotes.

As shown in FIG. 2, a banknote holding unit 29 connected with the transport unit 25 is provided to the banknote return opening 23. The banknote holding unit 29 is configured to receive and hold the banknotes transferred from the transport unit 25. The banknote return opening 23 is provided with a door 24 that can be optionally opened and closed. In the case in which the banknotes held in the banknote holding unit 29 are returned, a front wall of the banknote holding unit 29 is opened, as such the operator can take out the banknotes through the door 24. The door 24 is configured to be automatically opened when the banknotes are allowed to be taken out. As will be described later, in some cases, the banknotes held in the banknote holding unit 29 are transferred to a banknote storage cassette 41 (described later) located in the money storage unit 40, rather than taken out from the banknote return opening 23 by the operator.

The transport unit 25 has a function for transporting the banknotes, one sheet for each operation, successively, in the banknote handling apparatus 20. More specifically, in the transport unit 25, each banknote is transported along a transport route while being interposed between a pair of belts. As shown in FIG. 2, the transport route provided in the transport unit 25 is bifurcated at various points, and a bifurcating member (not shown) is provided at each point where the transport route is bifurcated. Each bifurcating member is composed of, for example, a bifurcating nail, and such bifurcating members are controlled by a control unit 15 which will be described later, respectively. Further, as shown in FIG. 2, the transport unit 25 is configured to transport the banknotes inserted through the banknote insertion opening 21 to the banknote eject opening 22, banknote holding unit 29 or recycling-style banknote storage units 27 which will be described later. Additionally, the transport unit 25 has a function to transport the banknotes temporarily stored in each recycling-style banknote storage unit 27 to the banknote eject opening 22 or banknote holding unit 29.

As shown in FIG. 2, the discriminating unit 26 adapted for discriminating the banknotes transported by the transport unit 25, one sheet for each operation, is provided with the transport unit 25. Namely, the discriminating unit 26 is adapted for discriminating each banknote transported by the transport unit 25, for the denomination, unfitness, damage of banknote, etc. More specifically, the discriminating unit 26 includes a magnetic sensor and/or optical sensor, and is configured to discriminate the banknotes, one sheet for each operation, in regard to the denomination of banknote, unfitness of banknote or the like, by using such a sensor. Each result of discrimination obtained by the discriminating unit 26 will be sent to the control unit 15 which will be described below.

In the banknote handling apparatus 20, the recycling-style banknote storage units 27 are provided, in a plural number (e.g., three), while being juxtaposed relative to one another. In this case, the recycling-style banknote storage units 27a to 27c are generally provided, corresponding to respective denominations of money. For instance, in the case in which Japanese yen banknotes are handled by the banknote handling apparatus 20, one-thousand-yen notes, five-thousand-yen notes and ten-thousand-yen notes are stored in the recycling-style banknote storage units 27a to 27c, respectively. In some cases, two-thousand-yen notes and five-thousand-yen notes are stored, in a mixed state, in the recycling-style banknote storage unit 27b. However, in the case in which US dollar banknotes (e.g., one-dollar notes, two-dollar notes, five-dollar notes, ten-dollar notes, twenty-dollar notes, fifty-dollar notes, one-hundred-dollar notes, etc.) or Chinese yuan notes (e.g., one-yuan notes, five-yuan notes, ten-yuan notes, twenty-yuan notes, fifty-yuan notes, one-hundred-yuan notes, etc.) are handled by the banknote handling apparatus 20, the number of denominations of money corresponding to such banknotes is of course greater than three. Therefore, in such a case, the number of recycling-style banknote storage units 27 should be increased, or otherwise the denominations of the banknotes to be stored in the respective recycling-style banknote storage units 27 should be limited. As shown in FIG. 2, each recycling-style banknote storage unit 27 includes a drum 27p which is rotatable in both forward and backward directions, and a pair of tapes are wound around each drum 27p. Namely, each banknote, transferred to each recycling-style banknote storage unit 27 from the transport unit 25, is wound around the drum 27p, one sheet for each operation, successively, while being interposed between the pair of tapes.

More specifically, each drum 27p is configured to be rotated, in both clockwise and counterclockwise directions in FIG. 2, about an axis vertical to the sheet of FIG. 2. To an outer circumferential face of each drum 27p, each end of the pair of tapes is attached at the same point. In this case, when each drum 27p is rotated in the counterclockwise direction in FIG. 2, the pair of tapes will be wound around the drum 27p. This operation of the drum 27p is controlled by the control unit 15 which will be described later. In this way, each banknote transferred to each recycling-style banknote storage unit 27 from the transport unit 25 is interposed between the pair of tapes, and then wound around each drum 27p, one sheet for each operation, together with the pair of tapes, with the rotation of the drum 27p in the counterclockwise direction in FIG. 2. During this operation, the plurality of banknotes will be wound around each drum 27p, one sheet for each operation, with a space. Contrary, when each drum 27p is rotated in the clockwise direction in FIG. 2, the pair of tapes wound around the drum 27p will be released therefrom, as such the banknotes stored in each recycling-style banknote storage unit 27 will be transferred to the transport unit 25.

It is noted that each recycling-style banknote storage unit 27 is not limited to the construction as described above, in which each drum is provided with the pair of tapes, such that each banknote can be wound around the drum, together with the pair of tapes, while being interposed therebetween. For instance, each recycling-style banknote storage unit 27 may be of a stacker-type.

The banknote holding unit 29 is provided in the banknote return opening 23 as described above, and is connected with the transport unit 25 as shown in FIG. 2. To the banknote holding unit 29, the banknotes inserted through the banknote insertion opening 21 and/or banknotes stored in each recycling-style banknote storage unit 27 will be transported by the transport unit 25. The banknote holding unit 29 is configured such that the banknotes transferred from the transport unit 25 can be held therein, in a plural number, in a bundled state. Meanwhile, when the banknotes held in the banknote holding unit 29 are returned, the front wall of the banknote holding unit 29 is opened as described above, as such the operator can take out the banknotes through the door 24. The door 24 is configured to be automatically opened when the banknotes are allowed to be taken out. In this case, when the banknotes are held in the banknote holding unit 29, the banknotes are temporarily placed on a temporary holding plate. In addition, when the banknotes held in the banknote holding unit 29 are stored in the banknote storage cassette 41, a stage provided in the banknote storage cassette 41 is moved to receive the banknotes placed on the temporary holding plate of the banknote holding unit 29, and then lowered from the banknote holding unit 29 into the banknote storage cassette 41 after receiving the banknotes thereon. Thereafter, the banknotes placed on the stage are pressed, from above, by a pressing member, so as to be stored in the banknote storage cassette 41.

Next, the construction of the coin handling apparatus 30 will be described with reference to FIGS. 1 and 3. As shown in FIGS. 1 and 3, the coin handling apparatus 30 includes a coin insertion opening 31 configured for taking the coins into the coin handling apparatus 30, and a coin return opening 32 configured for ejecting the coins unidentifiable by a discriminating unit 35a which will be described later or the like, among the coins taken into the coin handling apparatus 30, as well as for returning the coins not allowed to be stored in the money storage unit 40, among the coins taken into the coin handling apparatus 30, to the exterior of the coin handling apparatus 30. In addition, as shown in FIG. 3, a transport unit 35, which is adapted for transporting the coins inserted in the coin handling apparatus 30 through the coin insertion opening 31, is provided in the coin handling apparatus 30.

The coin insertion opening 31 is configured such that the operator can insert one or a plurality of coins, collectively, into the coin handling apparatus 30, therethrough. The coins inserted through the coin insertion opening 31 are then transferred to the interior of the coin handling apparatus 30.

The coin return opening 32 is connected with a downstream end of the transport unit 35, so that the coins transferred from the transport unit 35 can be accumulated in the coin return opening 32. Thus, the operator can take out the coins accumulated in the coin return opening 32. To the coin return opening 32, as described above, the coins unidentifiable by the discriminating unit 35a which will be described later or the like, among the coins taken into the coin handling apparatus 30, as well as the coins not allowed to be stored in the money storage unit 40, among the coins taken into the coin handling apparatus 30, are transported, respectively. Thereafter, such coins will be returned to the exterior of the coin handling apparatus 30 via the coin return opening 32.

As shown in FIG. 3, a coin feed-out unit 33 is provided in the coin handling apparatus 30. The coin feed-out unit 33 is in communication with the coin insertion opening 31 and configured to temporarily accumulate therein the coins inserted through the coin insertion opening 31 by the operator as well as feed out therefrom the accumulated coins to the transport unit 35 which will be described later. To the coin feed-out unit 33, a rotary disc (not shown) adapted for feeding out the coins is provided, so that the coins can be fed out to the transport unit 35, one coin for each operation, due to the rotary disc.

The transport unit 35 has a function for transporting the coins, one coin for each operation (or one by one), successively, in the coin handling apparatus 30. More specifically, in the transport unit 35, the coins are transported, one coin for each operation, with a space, by a coin transport belt (not shown), while standing somewhat obliquely. As shown in FIG. 3, an upstream end and the downstream end of the transport unit 35 are connected to the coin feed-out unit 33 and the coin return opening 32, respectively.

As shown in FIG. 3, the discriminating unit 35a, adapted for discriminating the coins transported by the transport unit 35, one coin for each operation, is provided with the transport unit 35. Namely, the discriminating unit 35a is adapted for discriminating each coin transported by the transport unit 35, for the denomination of coin, unfitness of coin, etc. More specifically, the discriminating unit 35a includes a magnetic sensor and/or optical sensor, and is configured to discriminate the coins, one coin for each operation, in regard to the denomination of coin, unfitness of coin or the like, by using such a sensor. Each result of discrimination obtained by the discriminating unit 35a will be sent to the control unit 15 which will be described later.

In the coin handling apparatus 30, recycling-style coin storage units 34 are provided, in a plural number (e.g., six), while being juxtaposed relative to one another. In this case, the coins are taken in and taken out from a top portion of each cylindrical recycling-style coin storage unit 34. Each recycling-style coin storage unit 34 is configured to extend in a vertical direction. In this embodiment, the recycling-style coin storage units 34a to 34f are generally provided, corresponding to respective denominations of money. For instance, in the case in which Japanese yen coins are handled by the coin handling apparatus 30, one-yen coins, five-yen coins, ten-yen coins, fifty-yen coins, one-hundred-yen coins and five-hundred-yen coins are stored in the recycling-style coin storage units 34a to 34f, respectively. Meanwhile, in the case in which US dollar coins (e.g., one-cent coins, five-cent coins, ten-cent coins, twenty five-cent coins, fifty-cent coins and one-dollar coins, etc.) or Chinese yuan coins (e.g., one-fen coins, two-fen coins, five-fen coins, one-chiao coins, five-chiao coins, one-chiao coins, etc.) are handled by the coin handling apparatus 30, the recycling-style coin storage units 34, respectively corresponding to such denominations of money, should be provided. In this case, the coins are stored in a stacked state, one on another, in each recycling-style coin storage unit 34.

As shown in FIG. 3, in a middle portion of the transport unit 35, seven sorting holes 36 are provided, in succession, with a space, from the coin feed-out unit 33 toward the downstream end. The sorting hole 36 located on the most upstream side of the seven sorting holes 36 (i.e., the sorting hole 36 provided for overflowing coins) is provided for directly transferring the coins from the transport unit 35 to a lateral transport unit 38 which will be described later. More specifically, the most upstream sorting hole 36 is configured to transfer the coins onto the lateral transport unit 38 when the result of discrimination obtained by the discriminating unit 35a satisfies a predetermined condition (e.g., when the recycling-style coin storage unit 34 corresponding to the denomination of the coins discriminated by the discriminating unit 35a is completely filled). Meanwhile, second to seventh sorting holes 36 from the upstream side are provided, corresponding to the recycling-style coin storage units 34a to 34f, respectively.

As shown in FIG. 3, on the top portion of each recycling-style coin storage unit 34 extending in a vertical direction, a coin temporary holding unit 39 for each denomination of money, which is adapted for temporarily holding the coins, is provided. In this way, the coins fallen downward from the transport unit 35 via each sorting hole 36 will be temporarily held by such a coin temporary holding unit 39 for each denomination of money. For instance, the coin temporary holding unit 39 is configured to hold about ten coins for each denomination of money. Then, such coins held by the coin temporary holding unit 39 will be stored in each recycling-style coin storage unit 34, for each denomination of money. In this case, the coin temporary holding unit 39 includes a discharging member, so that the coins temporarily stored in the coin temporary holding unit 39 can also be discharged onto the lateral transport unit 38 which will be described later, by such a discharging member.

On the other hand, in the case in which the coins stored in each recycling-style coin storage unit 34 are taken out therefrom, a stage (not shown) provided at a bottom portion of the recycling-style coin storage unit 34 is first moved upward, so as to place the coins thereon. Then, the coins placed on the stage are transferred to the coin temporary holding unit 39 for each denomination of money, and discharged onto the lateral transport unit 38 by the discharging member of the coin temporary holding unit 39.

As shown in FIG. 3, a coin holding unit 37a is provided in the coin handling apparatus 30, and a chute 37b is located above the coin holding unit 37a. In this way, the coins transferred from the lateral transport unit 38 which will be described later onto the chute 37b are further transferred into the coin holding unit 37a through the chute 37b. Thereafter, the coins temporarily held in the coin holding unit 37a will be transferred into a coin storage cassette 42 (described below) located in the coin storage unit 40.

As shown in FIG. 3, in the coin handling apparatus 30, the lateral transport unit 38, which includes, for example, a circular belt 38a extending in a generally horizontal direction, is provided in the vicinity of each recycling-style coin storage unit 34 extending in the vertical direction. The circular belt 38a is provided across two pulleys respectively located at the same level. With rotation of one of the two pulleys in both forward and backward directions, the circular belt 38a can be circulated in both of the clockwise and counterclockwise directions in FIG. 3. One end of the lateral transport unit 38 is positioned in the coin feed-out unit 33, while the other end thereof is located in the vicinity of an upper portion of the chute 37b. As discussed above, the circular belt 38a of the lateral transport unit 38 can be rotated in both forward and backward directions, wherein the coins placed on the lateral transport unit 38 will be transported to the coin feed-out unit 33 when the circular belt 38a is rotated in the counterclockwise direction in FIG. 3. On the other hand, when the circular belt 38a is rotated in the clockwise direction in FIG. 3, the coins placed on the lateral transport unit 38 will be transferred to the chute 37b and finally held in the coin holding unit 37a.

Next, other various mechanisms provided to the money handling machine 10 will be described. As shown in FIG. 1, an operating unit 45 adapted for allowing the operator to provide various instructions to the control unit 15 (described later) of the money handling machine 10 and a display unit 44 adapted for displaying details of handling the money and the like in the money handling machine 10 are provided on a top face of the casing 11 of the money handling machine 10. The operating unit 45 includes, for example, a numeric key pad, a confirmation key, a start key, a cancelling key and a reset key, such that the operator can provide various instructions to the control unit 15 of the money handling machine 10 by pushing these keys. The display unit 44 is composed of, for example, a liquid crystal display (LCD).

At a front face of the casing 11, a printer 43 for printing the details of handling the money and the like in the money handling machine 10 and a card reader 46 for checking the operator's authority to operate the money handling machine 10 are provided, respectively.

In addition, as shown in FIG. 1, the money storage unit 40 is provided at a lower portion of the casing 11 of the money handling machine 10. The money storage unit 40 includes the banknote storage cassette 41 for storing the banknotes therein and the coin storage cassette 42 for storing the coins therein. Namely, the banknote storage cassette 41 serves to store therein the banknotes once held in the banknote holding unit 29 of the banknote handling apparatus 20, while the coin storage cassette 42 serves to store therein the coins once held in the coin holding unit 37a of the coin handling apparatus 30. By a certain person for collecting the money, such as by a guard of a security company entrusted with a collecting business for takings, each cassette 41, 42 of the money storage unit 40 will be drawn out forward from the casing 11. Thus, the certain person for collecting the money can collect each cassette 41, 42, itself.

Next, the control unit 15 adapted for controlling each component of the money handling machine 10 will be described with reference to FIG. 4. The control unit 15 is located in the casing 11 of the money handling machine 10.

As shown in FIG. 4, to the control unit 15, the respective components of the banknote handling apparatus 20 (e.g., the transport unit 25, discriminating unit 26, recycling-style banknote storage units 27, banknote stage 28, banknote holding unit 29, door 24, etc.), respective components of the coin handling apparatus 30 (e.g., the coin feed-out unit 33, transport unit 35, discriminating unit 35a, lateral transport unit 38, recycling-style coin storage units 34 including the coin temporary holding unit 39 for each denomination of money, coin holding unit 37a, etc.), display unit 44, operating unit 45, printer 43, card reader 46 and the like are connected, respectively.

To the control unit 15, the results of discrimination for the banknotes due to the discriminating unit 26 of the banknote handling apparatus 20 and/or the results of discrimination for the coins due to the discriminating unit 35a of the coin handling apparatus 30 will be sent. In addition, information on each card that is read by the card reader 46 will be sent to the control unit 15. The control unit 15 can control the respective components of the banknote handling apparatus 20 and/or coin handling apparatus 30, as well as control the display unit 44, operating unit 45 and/or printer 43. Furthermore, the control unit 15 can communicate with a host system (see FIG. 4) installed in, for example, a security company entrusted with the collecting business, a point-of-sale system (or POS system) and/or the like, via an interface 16 connected with the control unit 15.

Next, operation of the money handling machine 10 constructed as described above will be discussed.

As the operation of the money handling machine 10 as described above, there are three modes, i.e., an interface confirmation mode, an operation mode and a maintenance mode. The operator can select the interface confirmation mode, operation mode or maintenance mode, by using the operating unit 45.

What is meant by the “interface confirmation mode” is a mode, in which whether or not the money handling machine 10 is in communication with the host system or the like via the interface 16 is confirmed, in an initial state of the money handling machine 10 or when the money handling machine 10 is installed. In such an interface confirmation mode, when the money handling machine 10 is in communication with the host system or the like via the interface 16, various setting data can be sent to the money handling machine 10 from the host system or the like.

The operation mode includes two options, i.e., an on-line mode in which the money handling machine 10 is in communication with the host system or the like, and an off-line mode in which the communication between the money handling machine 10 and the host system or the like is shut off. Furthermore, the on-line mode includes an opened shop mode and a closed shop mode. In the opened shop mode, the operator can carry out the complementing process, depositing process, disbursing process, delivery process, mass delivery process, exchange from large denomination to small denomination process, exchange from small denomination to large denomination process, checking process, counting process and the like, which will be described later, respectively. Additionally, in this opened shop mode, the collection of each cassette 41, 42 itself of the money storage unit 40 can also be carried out, by a certain person for collecting the money, such as by a guard of a security company entrusted with the collecting business for takings. On the other hand, in the closed shop mode, only the collection of each cassette 41, 42 of the money storage unit 40 by such a certain person for collecting the money can be carried out. It is noted that switching between the opened shop mode and the closed shop mode may be automatically performed in accordance with a period of time or the like. In the off-line mode, communication of information to the host system or the like is not performed, and results of the depositing process and/or the like will be stored in a storage medium (not shown) provided in the money handling machine 10. The selection of each mode described above is carried out by the operator by using the operating unit 45.

In the maintenance mode, a person in charge of maintenance carries out the maintenance for each component of the banknote handling apparatus 20 and/or coin handling apparatus 30 of the money handling machine 10. Such maintenance may be carried out in a working site in which the money handling machine 10 is installed, or performed in a factory or the like after bringing it back thereto.

Now, for each of the aforementioned complementing process, depositing process, disbursing process, delivery process, mass delivery process, exchange from large denomination to small denomination process, exchange from small denomination to large denomination process, checking process and counting process, details will be discussed with reference to FIGS. 5 to 20.

### (Complementing Process)

First, the complementing process for the banknotes and/or coins will be discussed. The term “complementing process for the banknotes and/or coins” means a process for complementing the banknotes into each recycling-style banknote storage unit 27 of the banknote handling apparatus 20, for each denomination of money, and/or process for complementing the coins into each recycling-style coin storage unit 34 of the coin handling apparatus 30, for each denomination of money.

The complementing process for the banknotes in the banknote handling apparatus 20 will be described with reference to FIGS. 5A and 5B. When an instruction for complementing the banknotes is sent to the control unit 15 by the operator via the operating unit 45, and when the operator inserts the banknotes into the banknote insertion opening 21 of the banknote handling apparatus 20, the banknotes inserted into the banknote insertion opening 21 will be transported by the transport unit 25, one sheet for each operation, and then the discrimination for the banknotes will be performed by the discriminating unit 26. As shown in FIG. 5A, in the case in which the banknotes are discriminated, as normal ones, by the discriminating unit 26, and in which the recycling-style banknote storage unit 27 corresponding to the denomination of the banknotes is not yet filled therewith, the banknotes will be transported to the recycling-style banknote storage unit 27, corresponding to the denomination of the banknotes, by the transport unit 25. On the other hand, as is also shown in FIG. 5A, in the case in which the banknotes are discriminated, as unfit ones or the like to be ejected, by the discriminating unit 26, such banknotes will be transferred to the banknote eject opening 22. Meanwhile, in the case in which the recycling-style banknote storage unit 27, corresponding to the denomination of the banknotes discriminated by the discriminating unit 26, is completely filled therewith, the banknotes will be transferred to the banknote holding unit 29. Thereafter, with the automatic opening of the door 24, such overflowing banknotes held in the banknote holding unit 29 will be taken out by the operator. It is also contemplated that in the case in which the recycling-style banknote storage unit 27 corresponding to the denomination of the banknotes discriminated by the discriminating unit 26 is completely filled therewith, such banknotes may be transported to the banknote eject opening 22 by the transport unit 25. During such processes for the banknotes as shown in FIG. 5A, the counting process for the banknotes is performed by the discriminating unit 26.

After the processes as described above for the banknotes are performed, when the operator pushes “the cancelling key” provided in the operating unit 45 so as to send an instruction, for cancelling the complementing process, to the control unit 15, the banknotes stored in each recycling-style banknote storage unit 27 will be transported to the banknote eject opening 22 by the transport unit 25 via the discriminating unit 26, as shown in FIG. 5B.

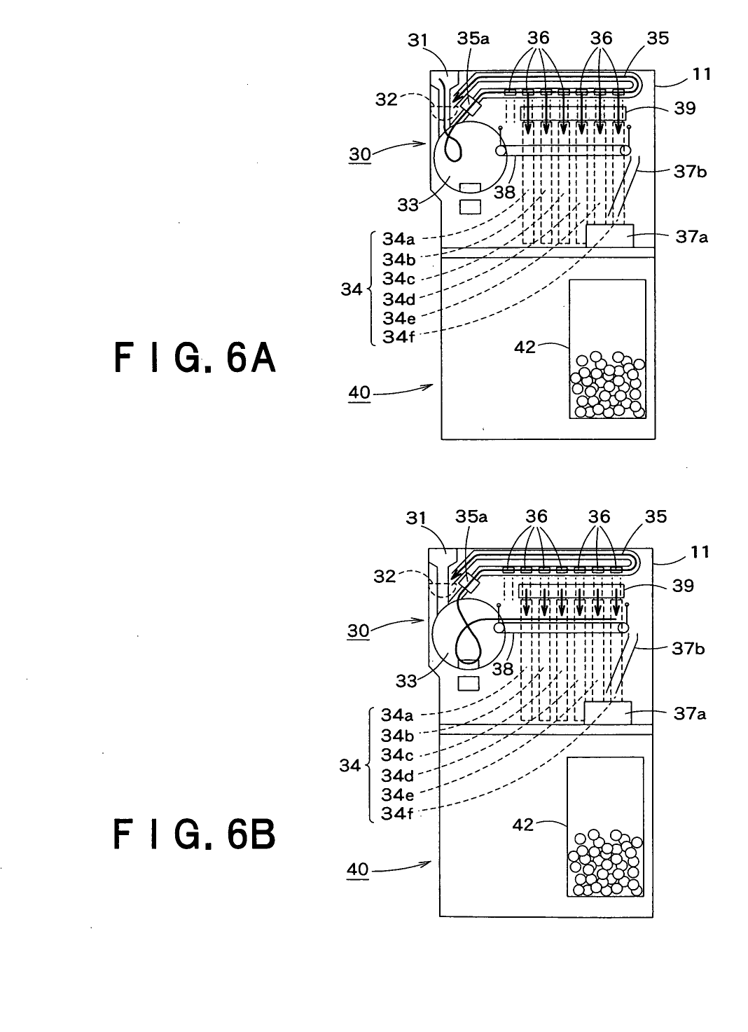

Next, the complementing process in the coin handling apparatus 30 will be described with reference to FIGS. 6A and 6B. When an instruction for complementing the coins is sent to the control unit 15 by the operator via the operating unit 45, and when the operator inserts the coins into the coin insertion opening 31 of the coin handling apparatus 30, as shown in FIG. 6A, the coins inserted into the coin insertion opening 31 will be first transported to the coin feed-out unit 33, and then fed out from the coin feed-out unit 33 to the transport unit 35, one coin for each operation. Thereafter, the discrimination for the coins fed to the transport unit 35 will be performed by the discriminating unit 35a. As a result, the coins discriminated, as normal ones, by the discriminating unit 35a, will be held in the coin temporary holding unit 39 for each denomination of money. In this case, however, the coins held in excess for the volume of the coin temporary holding unit 39 will be transferred to the lateral transport unit 38 via the sorting hole 36 provided for overflowing (that is located on the most upstream side in the transport unit 35). Thereafter, once the coins held in the coin temporary holding unit 39 are stored in each recycling-style coin storage unit 34, the coins transferred onto the lateral transport unit 38 will be transported to the coin feed-out unit 33, and the feed-out and discrimination processes for such coins will be performed again. Subsequently, the coins will be fallen down through each sorting hole 36, held in the coin temporary holding unit 39, for each denomination of money, and then stored in each recycling-style coin storage unit 34. On the other hand, as is also shown in FIG. 6A, in the case in which the coins are discriminated, as unidentifiable ones or the like to be ejected, by the discriminating unit 35a, such coins will be transported to the coin return opening 32 by the transport unit 35. During such processes for the coins as shown in FIG. 6A, the counting process for the coins is performed by the discriminating unit 35a.

After the processes as described above for the coins are performed, when the operator pushes “the cancelling key” provided in the operating unit 45 so as to send an instruction, for cancelling the complementing process, to the control unit 15, the coins stored in each recycling-style coin storage unit 34 will be transported to the coin temporary holding unit 39 for each denomination of money, transferred from the coin temporary holding unit 39 to the coin feed-out unit 33 by the lateral transport unit 38, and finally fed to the coin return opening 32 from the coin feed-out unit 33 via the transport unit 35, as shown in FIG. 6B.

### (Depositing Process)

The depositing process includes a mode with the delivery process and a mode without the delivery process. Namely, the depositing process, in the mode with the delivery process, means a process for depositing the money into the money handling machine 10 and directly performing the delivery process, successively. More specifically, in this process, the banknotes are temporarily held in each recycling-style banknote storage unit 27, then held in the banknote holding unit 29, and finally stored in the banknote storage cassette 41. Meanwhile, the coins are held in the coin temporary holding unit 39 for each denomination of money, then held in the coin holding unit 37a, and finally stored in the coin storage cassette 42. On the other hand, the depositing process, in the mode without the delivery process, means a process for performing only the depositing process for the money into the money handling machine. Thereafter, if the delivery of the money to the money storage unit 40 is desired, the delivery process will be performed independently. It is noted that the depositing process, in the mode with or without the delivery process, can be optionally set upon installing the money handling machine 10.

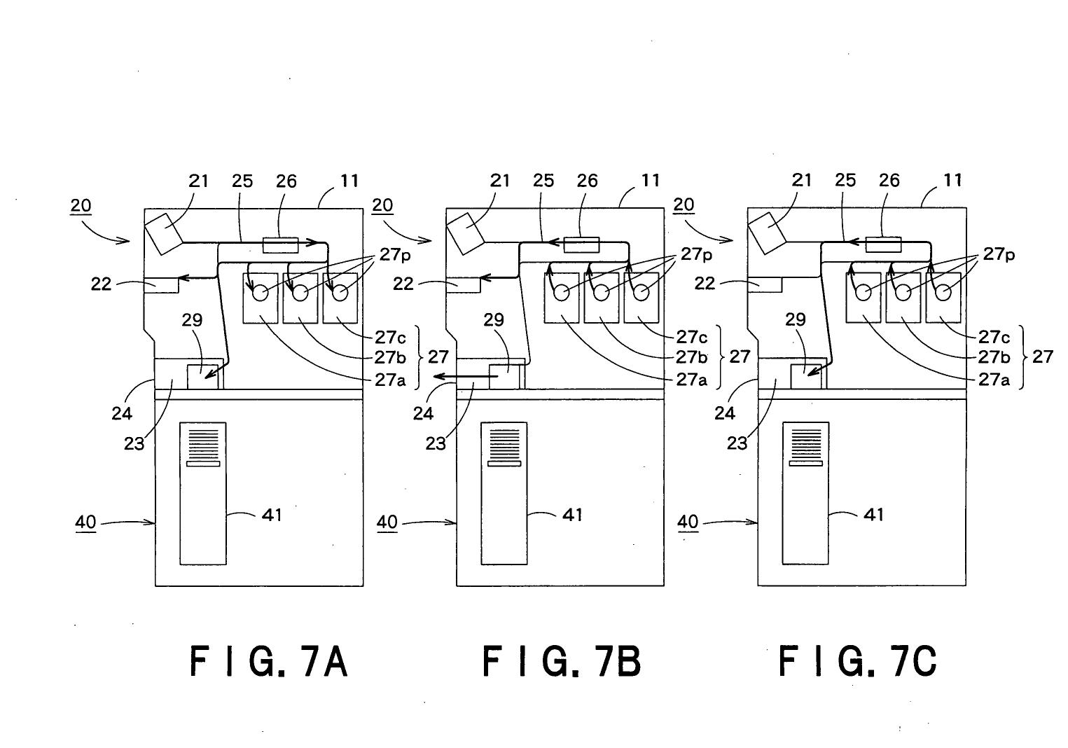

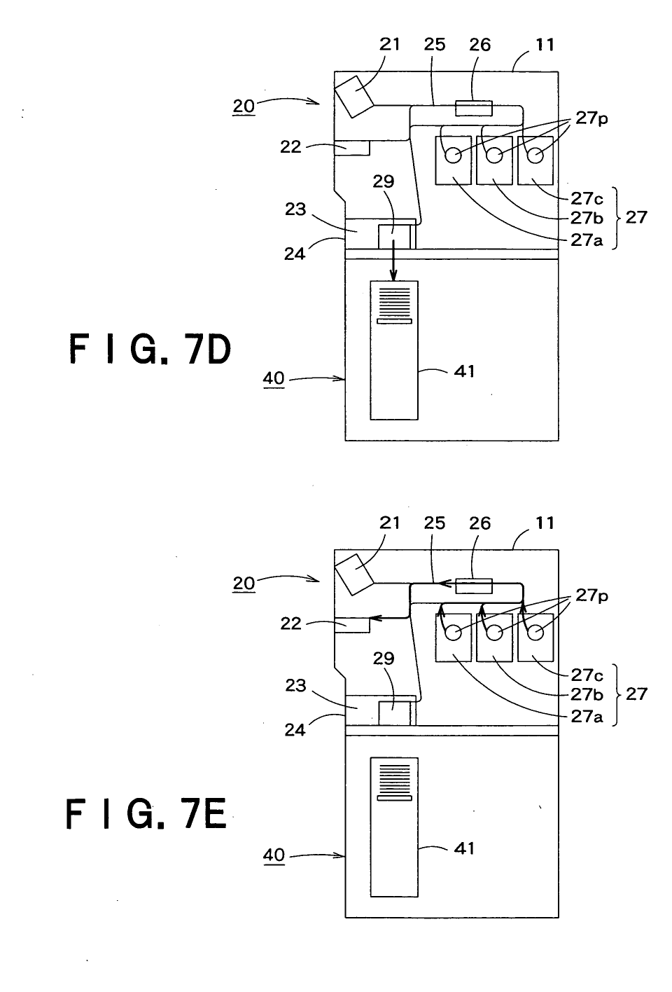

Now, the depositing process for the banknotes into the banknote handling apparatus 20 will be described with reference to FIGS. 7A to 7E. As the depositing process for the banknotes into the banknote handling apparatus 20, there are two modes, as described above, i.e., the mode with the delivery process, in which the depositing process is provided together with the delivery process and the mode without the delivery process, in which the depositing process is provided without or independently of the delivery process.

When an instruction for depositing the banknotes is sent to the control unit 15 by the operator via the operating unit 45, and when the operator inserts the banknotes into the banknote insertion opening 21 of the banknote handling apparatus 20, the banknotes inserted into the banknote insertion opening 21 will be transported by the transport unit 25, one sheet for each operation, and then the discrimination for the banknotes will be performed by the discriminating unit 26. As shown in FIG. 7A, in the case in which the banknotes are discriminated, as normal ones, by the discriminating unit 26, and in which the recycling-style banknote storage unit 27 corresponding to the denomination of the banknotes is not yet filled therewith, the banknotes will be transferred to the recycling-style banknote storage unit 27 corresponding to the denomination of the banknotes by the transport unit 25. On the other hand, as is also shown in FIG. 7A, in the case in which the banknotes are discriminated, as damaged or unfit ones or the like to be ejected, by the discriminating unit 26, such banknotes will be transferred to the banknote eject opening 22.

In addition, in the case in which the mode with the delivery process has been set in advance, and in which the recycling-style banknote storage unit 27 corresponding to the denomination of the banknotes discriminated by the discriminating unit 26 is completely filled therewith, the banknotes will be transported to the banknote holding unit 29 by the transport unit 25, as shown in FIG. 7A. Similarly, also in the case in which the mode without the delivery process has been set in advance, and in which the recycling-style banknote storage unit 27 corresponding to the denomination of the banknotes discriminated by the discriminating unit 26 is completely filled therewith, the banknotes will be transferred to the banknote holding unit 29. Thereafter, with the automatic opening of the door 24, such overflowing banknotes held in the banknote holding unit 29 will be taken out by the operator. It is also contemplated that in the case in which the recycling-style banknote storage unit 27 corresponding to the denomination of the banknotes discriminated by the discriminating unit 26 is completely filled therewith, the banknotes may be transported to the banknote eject opening 22 by the transport unit 25.

During such processes for the banknotes as described above, in either of the mode with or without the delivery process, the counting process for the banknotes is performed by the discriminating unit 26.

After the processes as described above for the banknotes are performed, when the operator pushes “the cancelling key” provided in the operating unit 45 so as to send an instruction, for cancelling the depositing process, to the control unit 15, the banknotes stored in each recycling-style banknote storage unit 27 will be transported to the banknote eject opening 22 by the transport unit 25 via the discriminating unit 26, as shown in FIG. 7B. Thereafter, with the automatic opening of the door 24, the operator can take out the banknotes held in the banknote holding unit 29.

Once such processes as described above has been performed, if the process in the mode with the delivery process has been set in advance, the banknotes stored in each recycling-style banknote storage unit 27 will be transported to the banknote holding unit 29 by the transport unit 25 via the discriminating unit 26, as shown in FIG. 7C. During this operation, the counting process is performed by the discriminating unit 26. Furthermore, as shown in FIG. 7D, the banknotes held in the banknote holding unit 29 will be transferred to the banknote storage cassette 41 of the money storage unit 40.

After the depositing process as described above for the banknotes is carried out, a change counting process is provided, in some cases. The change counting process means a process for disbursing a change when the change is included in the money deposited. Specifically, in the case in which the change is included in the money that the operator has received from a customer and deposited the money into the money handling machine 10, the money corresponding to the change figured out by subtracting a price of an article from the deposited money will be disbursed. Such a disbursing process for the change from the money handling machine 10 will be herein referred to as the change counting process. More specifically, as shown in FIG. 7E, the banknotes stored in each recycling-style banknote storage unit 27 will be transported to the banknote eject opening 22 by the transport unit 25 via the discriminating unit 26.

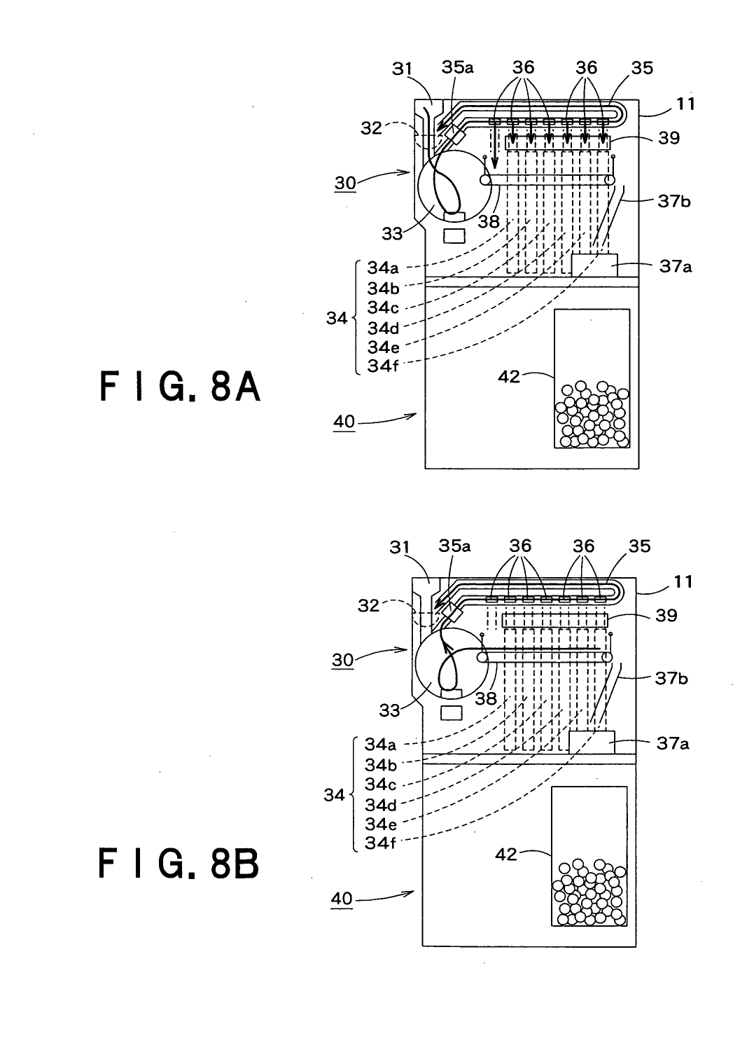

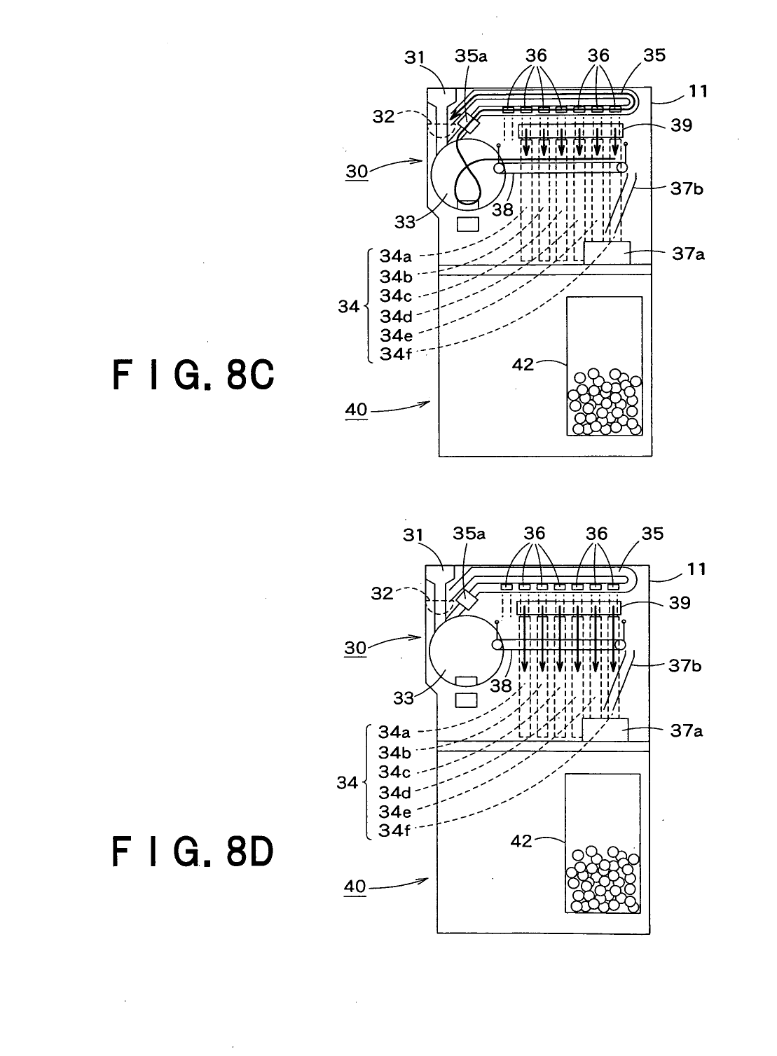

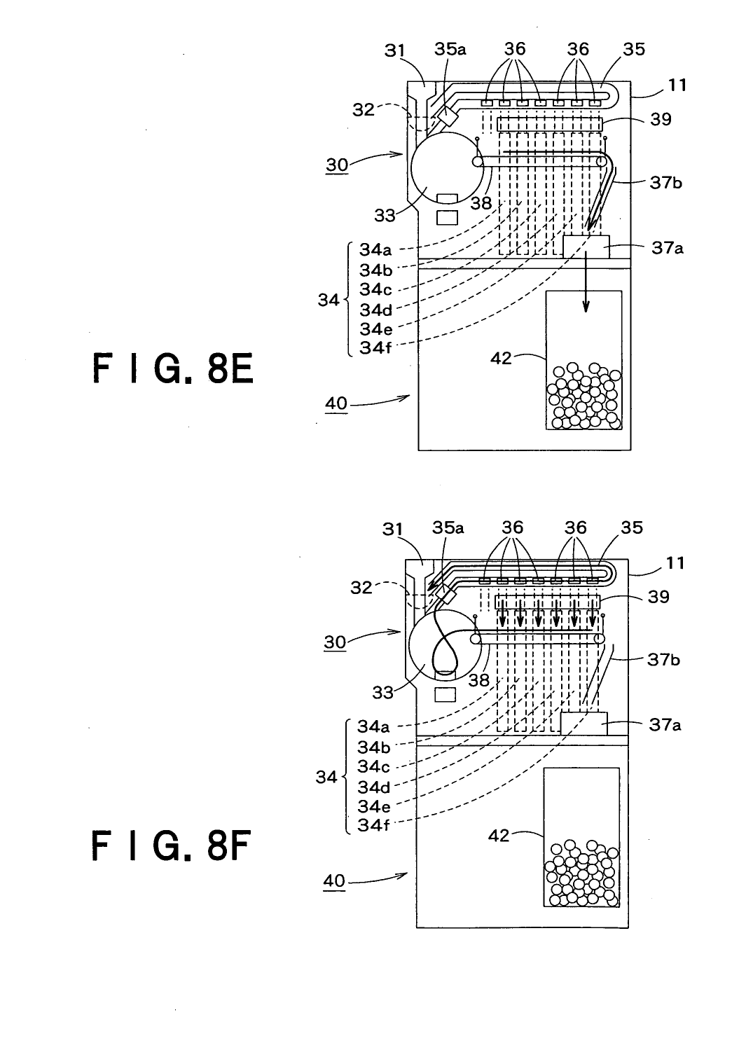

Next, the depositing process for the coins into the coin handling apparatus 30 will be described with reference to FIGS. 8A to 8F. When an instruction for depositing the coins is sent to the control unit 15 by the operator via the operating unit 45, and when the operator inserts the coins into the coin insertion opening 31 of the coin handling apparatus 30, the coins inserted into the coin insertion opening 31 will be first transferred to the coin feed-out unit 33, and then fed out to the transport unit 35 from the coin feed-out unit 33, one coin for each operation. Subsequently, the discriminating process for the coins fed to the transport unit 35 is performed by the discriminating unit 35a. As shown in FIG. 8A, the coins discriminated, as normal ones, by the discriminating unit 35a are held in the coin temporary holding unit 39 for each denomination of money. In this case, the coins held in excess for the volume of the coin temporary holding unit 39 will be transferred to the lateral transport unit 38 via the sorting hole 36 provided for overflowing (that is located on the most upstream side in the transport unit 35). Thereafter, when the coins held in the coin temporary holding unit 39 are stored in each recycling-style coin storage unit 34, the coins transferred onto the lateral transport unit 38 will be transported to the coin feed-out unit 33, and the feed-out and discrimination processes for such coins will be performed again. Subsequently, the coins will be held in the coin temporary holding unit 39 via each sorting hole 36, for each denomination of money. On the other hand, as is also shown in FIG. 8A, the coins discriminated, as unidentifiable ones or the like to be ejected, by the discriminating unit 35a, will be transferred to the coin return opening 32 by the transport unit 35. During such processes for the coins as shown in FIG. 8A, the counting process for the coins is performed by the discriminating unit 35a.

After the processes as described above for the coins are performed, when the operator pushes “the confirmation key” provided in the operating unit 45 so as to send an instruction, for confirmation of the depositing process, to the control unit 15, the coins held in the coin temporary holding unit 39 for each denomination of money will be transferred into each recycling-style coin storage unit 34 from the coin temporary holding unit 39, as shown in FIG. 8D.

After the processes as described above for the coins are performed, when the operator pushes “the cancelling key” provided in the operating unit 45 so as to send an instruction, for cancelling the depositing process, to the control unit 15, the coins present on the lateral transport unit 38 will be first transferred to the coin feed-out unit 33, and then transported to the coin return opening 32 from the coin feed-out unit 33 via the transport unit 35, as shown in FIG. 8B. Thereafter, as shown in FIG. 8C, the coins held in the temporary holding unit 39 for each denomination of money will be transferred onto the lateral transport unit 38 from the temporary holding unit 39, then transported to the coin feed-out unit 33 by the lateral transport unit 38, and finally fed to the coin return opening 32 from the coin feed-out unit 33 via the transport unit 35.

In the case in which the recycling-style coin storage unit 34 corresponding to a certain denomination of money of the coins is filled therewith, as shown in FIG. 8E, the coins of the denomination of money held in the coin temporary holding unit 39 for each denomination of money will be released from the coin temporary holding unit 39 and fallen down onto the lateral transport unit 38. Thereafter, the coins are transported to chute 37b by the lateral transport unit 38, and transferred to the coin holding unit 37a through the chute 37b.

After the depositing process as described above for the coins is carried out, the change counting process will be performed if a change is included in the deposited money. Specifically, in the case in which the change is included in the money that the operator has received from a customer and deposited the money into the money handling machine 10, the money corresponding to the change figured out by subtracting a price of an article from the deposited money will be disbursed. More specifically, the coins held in the coin temporary holding unit 39 for each denomination of money are once stored in each recycling-style coin storage unit 34. Thereafter, as shown in FIG. 8F, the coins corresponding to the change will be transferred to the coin temporary holding unit 39 from the recycling-style coin storage unit 34, and then transported to the coin return opening 32, via the lateral transport unit 38, coin feed-out unit 33 and transport unit 35, from the coin temporary holding unit 39.

### (Disbursing Process)

Next, the disbursing process for the banknotes and/or coins will be described. What is meant by the “disbursing process for the banknotes and/or coins” is a process for disbursing the banknotes stored in each recycling-style banknote storage unit 27 of the banknote handling apparatus 20 to the exterior of the banknote handling apparatus 20 and/or a process for disbursing the coins stored in each recycling-style coin storage unit 34 of the coin handling apparatus 30 to the exterior of the coin handling apparatus 30.

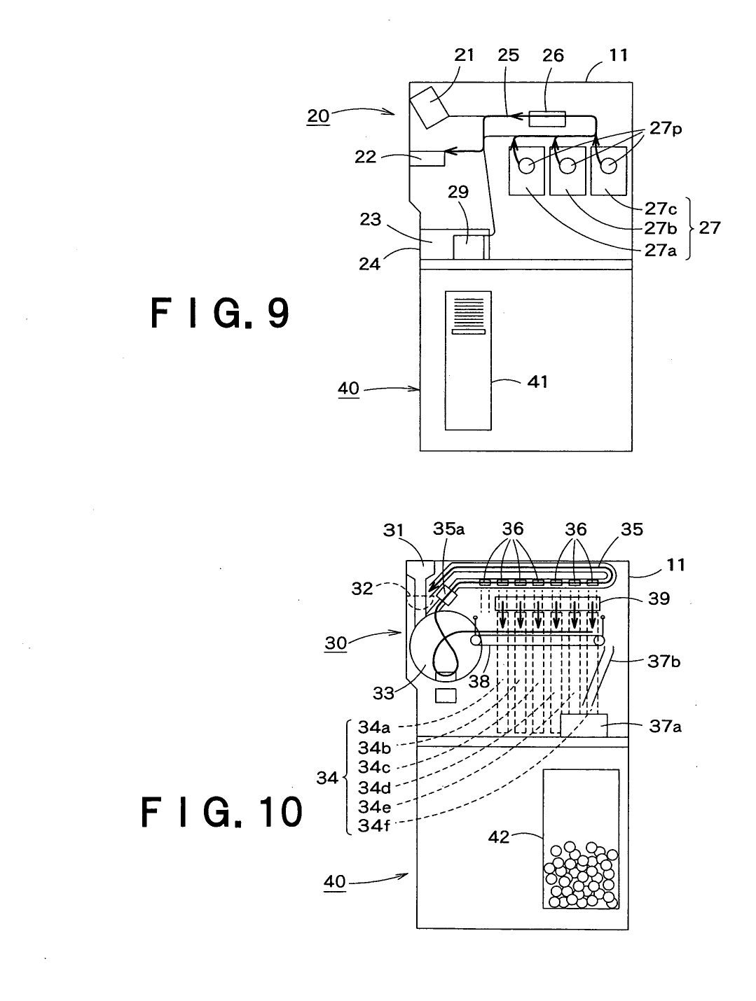

First, the disbursing process for the banknotes in the banknote handling apparatus 20 will be described with reference to FIG. 9. In a state in which the banknotes are stored in each recycling-style banknote storage unit 27 of the banknote handling apparatus 20, when an instruction for disbursing the banknotes is sent to the control unit 15 by the operator via the operating unit 45, the banknotes stored in each recycling-style banknote storage unit 27 will be transported to the banknote eject opening 22 by the transport unit 25 via the discriminating unit 26, as shown in FIG. 9. As described above, the banknote eject opening 22 also serves as a disbursing opening for disbursing the changes or the like. During such a disbursing process for the banknotes as shown in FIG. 9, the counting process for the banknotes is also performed by the discriminating unit 26.

Next, the disbursing process for the coins in the coin handling apparatus 30 will be described with reference to FIG. 10. In a state in which the coins are stored in each recycling-style coin storage unit 34 of the coin handling apparatus 30, when an instruction for disbursing the coins is sent to the control unit 15 by the operator via the operating unit 45, the coins will be transferred to the coin temporary holding unit 39 for each denomination of money, from the recycling-style coin storage unit 34, as shown in FIG. 10, then transferred to the coin return opening 32, via the lateral transport unit 38, coin feed-out unit 33 and transport unit 35, from the coin temporary holding unit 39. It is noted that the coin return opening 32 also serves as a disbursing opening for the coins. During such processes, the counting process for the coins is also performed by the discriminating unit 35a.

### (Delivery Process)

Next, the delivery process for the banknotes and/or coins will be described.

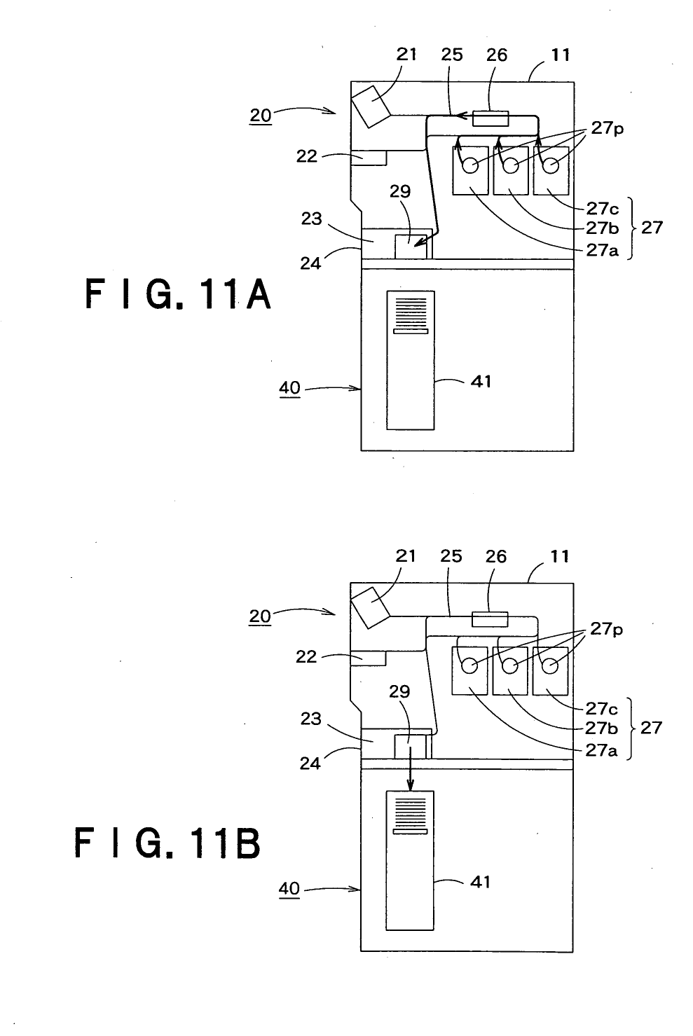

First, the delivery process for the banknotes in the banknote handling apparatus 20 will be described with reference to FIGS. 11A and 11B. In the case of the depositing process in the mode with the delivery process, the deposited banknotes stored in each recycling-style banknote storage unit 27 will be transported to and held in the banknote holding unit 29, without any operation provided by the operator (see FIG. 11A). Thereafter, with the “confirmation key” pushed at the operating unit 45, the banknotes held in the banknote holding unit 29 will be stored in the banknote storage cassette 41, thereby performing the delivery process (see FIG. 11B). On the other hand, in the case of the depositing process in the mode without the delivery process, the banknotes will be transported to and held in the banknote holding unit 29, from each recycling-style banknote storage unit 27, by a predetermined amount of money (e.g., an amount of money figured out by subtracting the money that is wanted to be remained, as the change, in the recycling-style banknote storage unit 27, from the deposited money) (see FIG. 11A). Thereafter, with the “confirmation key” pushed at the operating unit 45, the banknotes held in the banknote holding unit 29 will be stored in the banknote storage cassette 41, thereby performing the delivery process (see FIG. 11B). As described above, either of the mode with or without the delivery process has been set in advance.

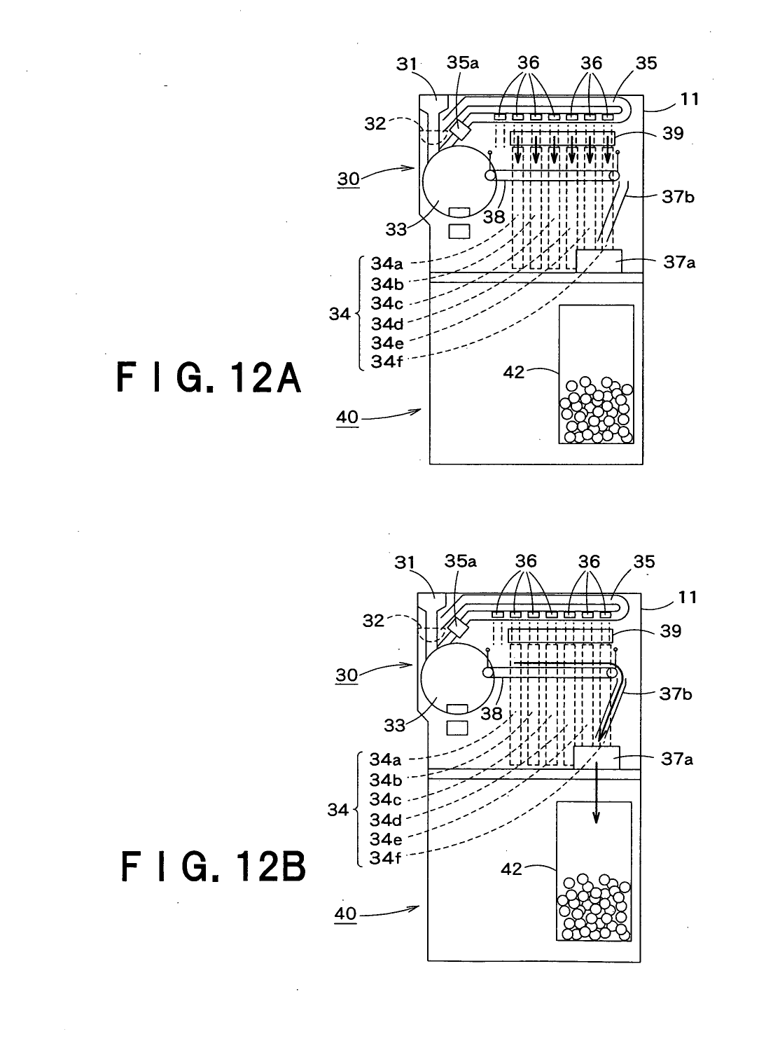

Next, the delivery process for the coins in the coin handling apparatus 30 will be described with reference to FIGS. 12A and 12B. In the case of the depositing process in the mode with the delivery process, the deposited coins stored in each recycling-style coin storage unit 34 will be transported to and held in the coin temporary holding unit 39 for each denomination of money, without any operation provided by the operator. Thereafter, the coins will be transferred to the lateral transport unit 38 from the coin temporary holding unit 39 (see FIG. 12A), and transferred and held in the coin holding unit 37a, via the chute 37b, from the lateral transport unit 38. Then, with the “confirmation key” pushed at the operating unit 45, the coins will be stored in the coin storage cassette 42, thereby performing the delivery process (see FIG. 12B). On the other hand, in the case of the depositing process in the mode without the delivery process, the coins will be transported to and held in the coin temporary holding unit 39 for each denomination of money from each recycling-style coin storage unit 34, by a predetermined amount of money (e.g., an amount of money figured out by subtracting the money that is wanted to be remained, as the change, in the recycling-style coin storage unit 34, from the deposited money). Then, the coins will be transferred to the lateral transport unit 38 from the coin temporary holding unit 39 (see FIG. 12A), and transferred and held in the coin holding unit 37a, via the chute 37b, from the lateral transport unit 38. Thereafter, with the “confirmation key” pushed at the operating unit 45, the coins will be stored in the coin storage cassette 42, thereby performing the delivery process (see FIG. 12B). As described above, either of the mode with or without the delivery process has been set in advance.

### (Mass Delivery Process)

Next, the mass delivery process for the banknotes and/or coins will be described. What is meant by the “mass delivery process for the banknotes and/or coins” is a process for delivering mass or a large amount of banknotes into the banknote storage cassette 41 of the money storage unit 40 and/or process for delivering mass coins into the coin storage cassette 42 of the money storage unit 40.

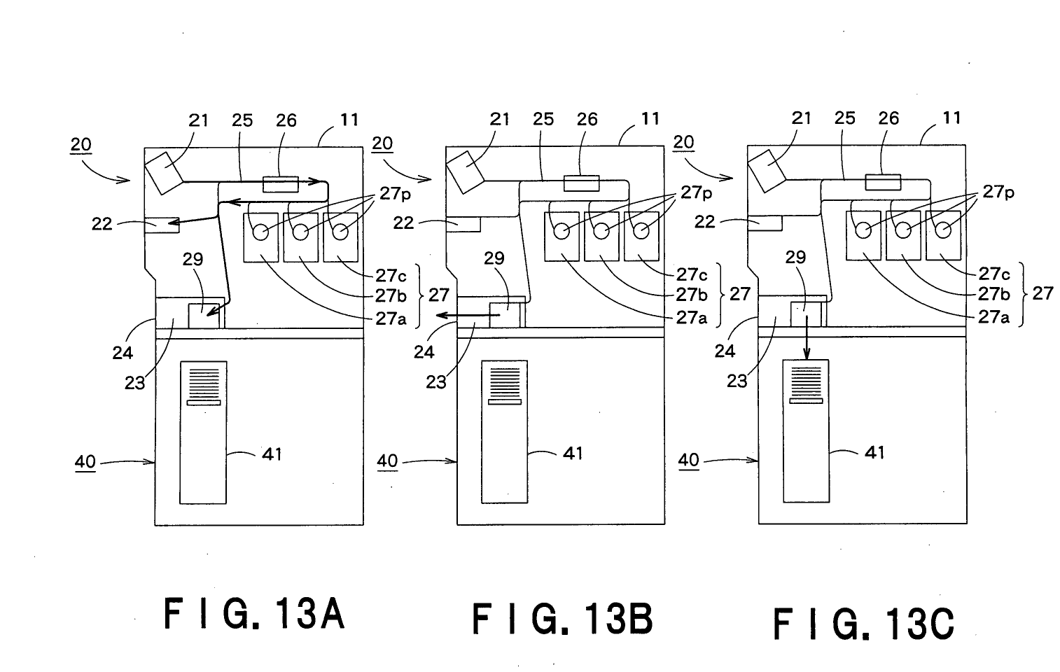

First, the mass delivery process for the banknotes in the banknote handling apparatus 20 will be described with reference to FIGS. 13A to 13C. When an instruction for the mass delivery process for the banknotes is sent to the control unit 15 by the operator via the operating unit 45, and when the operator inserts the banknotes into the banknote insertion opening 21 of the banknote handling apparatus 20, the banknotes inserted through the banknote insertion opening 21 will be transported by the transport unit 25, one sheet for each operation, and then the discrimination for the banknotes will be performed by the discriminating unit 26. As shown in FIG. 13A, in the case in which the banknotes are discriminated, as normal ones, by the discriminating unit 26, the banknotes will be transported to the banknote holding unit 29 by the transport unit 25. On the other hand, as is also shown in FIG. 13A, in the case in which the banknotes are discriminated, as damaged or unfit ones or the like to be ejected, by the discriminating unit 26, such banknotes will be sent to the banknote eject opening 22. During such processes for the banknotes as shown in FIG. 13A, the counting process for the banknotes is performed by the discriminating unit 26.

After the processes as described above for the banknotes are performed, when the operator pushes “the confirmation key” provided in the operating unit 45, the banknotes held in the banknote holding unit 29 will be transferred into the banknote storage cassette 41 of the money storage unit 40, as shown in FIG. 13C.

Meanwhile, after the processes as described above for the banknotes are performed, when the operator pushes “the cancelling key” provided in the operating unit 45 so as to send an instruction, for cancelling the depositing process, to the control unit 15, the banknotes held in the banknote holding unit 29 will be taken out by the operator, with the automatic opening of the door 24, as shown in FIG. 13B.

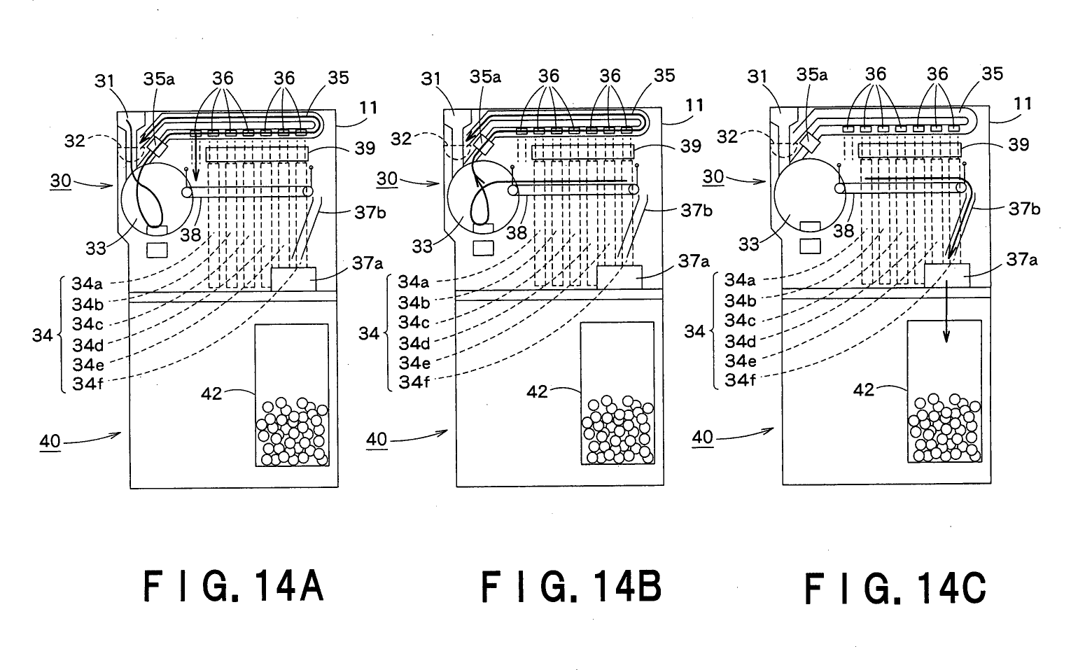

Next, the mass delivery process for the coins in the coin handling apparatus 30 will be described with reference to FIGS. 14A to 14C. When an instruction for the mass delivery for the coins is sent to the control unit 15 by the operator via the operating unit 45, and when the operator inserts the coins into the coin insertion opening 31 of the coin handling apparatus 30, the coins inserted into the coin insertion opening 31 will be first transported to the coin feed-out unit 33, and fed out from the coin feed-out unit 33 to the transport unit 35, one coin for each operation. Thereafter, the discrimination for the coins fed to the transport unit 35 will be performed by the discriminating unit 35a. As shown in FIG. 14A, in the case in which the coins are discriminated, as normal ones, by the discriminating unit 35a, the coins will be transferred onto the lateral transport unit 38 via the sorting hole 36 provided on the most upstream side in the transport unit 35. On the other hand, as is also shown in FIG. 14A, the coins discriminated, as unidentifiable ones or the like to be ejected, by the discriminating unit 35a, will be transported to the coin return opening 32 by the transport unit 35. During such processes for the coins as shown in FIG. 14A, the counting process for the coins is performed by the discriminating unit 35a.

After the processes as described above for the coins are performed, when the operator pushes “the confirmation key” provided in the operating unit 45, the coins present on the lateral transport unit 38 will be transported to the chute 37b by the lateral transport unit 38, and then transferred into the coin holding unit 37a through the chute 37b, as shown in FIG. 14C. Finally, the coins transferred into the coin holding unit 37a will be transported into the coin storage cassette 42 of the money storage unit 40.

Meanwhile, after the processes as described above for the coins are performed, when the operator pushes “the cancelling key” provided in the operating unit 45 so as to send an instruction, for cancelling the depositing process, to the control unit 15, the coins present on the lateral transport unit 38 will be transferred to the coin feed-out unit 33, and then transported to the coin return opening 32 from the coin feed-out unit 33 via the transport unit 35, as shown in FIG. 14B.

(Exchange from Large Denomination to Small Denomination Process and Exchange from Small Denomination to Large Denomination Process)

Next, the exchange from large denomination to small denomination process and exchange from small denomination to large denomination process for the banknotes and/or coins will be described. What is meant by the “the exchange from large denomination to small denomination process or exchange from small denomination to large denomination process” is a process for taking the banknotes and/or coins into the banknote handling apparatus 20 and/or coin handling apparatus 30 and then returning the banknotes and/or coins to the exterior of the banknote handling apparatus 20 and/or coin handling apparatus 30, wherein the total amount of the returned banknotes and/or coins is the same as that of the banknotes and/or coins taken into the banknote handling apparatus 20 and/or coin handling apparatus 30, while the denomination of money of the returned ones is different from that of the ones taken into the banknote handling apparatus 20 and/or coin handling apparatus 30.

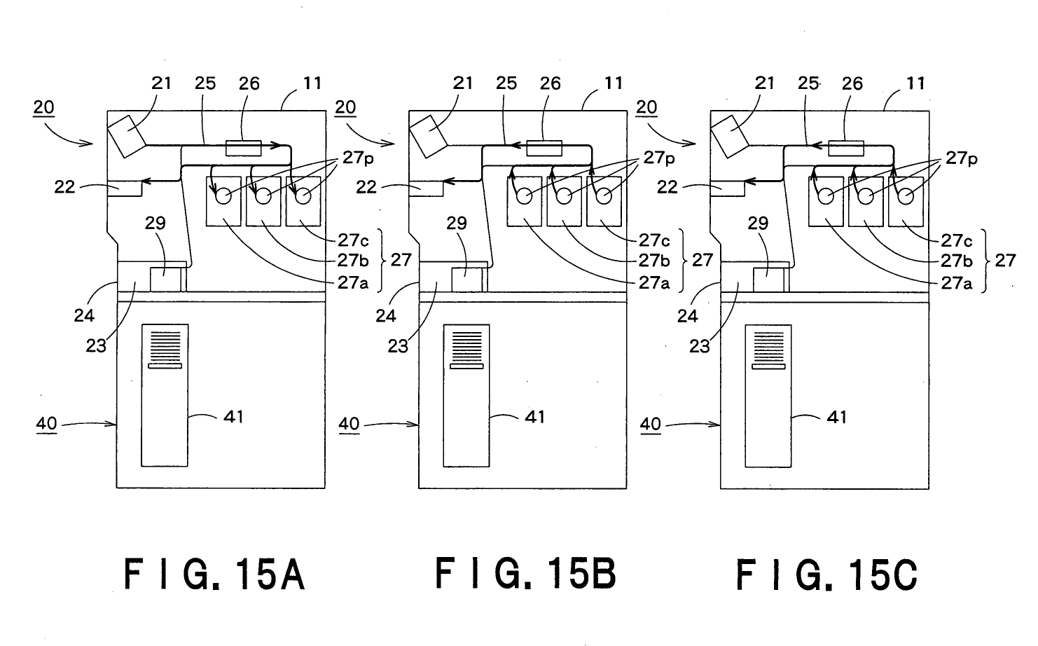

First, the exchange from large denomination to small denomination process and exchange from small denomination to large denomination process for the banknotes in the banknote handling apparatus 20 will be described with reference to FIGS. 15A to 15C. When an instruction for performing the exchange from large denomination to small denomination process or exchange from small denomination to large denomination process for the banknotes is sent to the control unit 15 by the operator via the operating unit 45, and when the operator inserts the banknotes into the banknote insertion opening 21 of the banknote handling apparatus 20, the banknotes inserted into the banknote insertion opening 21 will be transported by the transport unit 25, one sheet for each operation, and then the discrimination for the banknotes will be performed by the discriminating unit 26. As shown in FIG. 15A, in the case in which the banknotes are discriminated, as normal ones, by the discriminating unit 26, and in which the recycling-style banknote storage unit 27 corresponding to the denomination of the banknotes is not yet filled therewith, the banknotes will be transported to the recycling-style banknote storage unit 27 corresponding to the denomination of the banknotes by the transport unit 25. On the other hand, as is also shown in FIG. 15A, in the case in which the banknotes are discriminated, as unfit ones or the like to be ejected, by the discriminating unit 26, such banknotes will be transported to the banknote eject opening 22 by the transport unit 25. Meanwhile, in the case in which the recycling-style banknote storage unit 27 corresponding to the denomination of the banknotes discriminated by the discriminating unit 26 is completely filled therewith, the banknotes will also be transported to the banknote eject opening 22 by the transport unit 25. During such processes for the banknotes as shown in FIG. 15A, the counting process for the banknotes is performed by the discriminating unit 26.

After the processes as described above for the banknotes are performed, the banknotes different in the denomination of money from the banknotes taken into the banknote handling apparatus 20, among the banknotes of various denominations of money stored in each recycling-style banknote storage unit 27, will be transported to the banknote eject opening 22, automatically, due to the transport unit 25, via the discriminating unit 26, by the number of sheets that corresponds to the total amount of money of the banknotes taken into the banknote handling apparatus 20 (see FIG. 15B). During this process, the counting process for the banknotes is carried out by the discriminating unit 26. In this way, a confirmation process for checking whether or not the total amount of money of the banknotes taken into the banknote handling apparatus 20 is the same as the total amount of money of the banknotes returned to the exterior from the banknote handling apparatus 20 can be performed.

During such processes for the banknotes as described above, when the operator pushes “the cancelling key” provided in the operating unit 45 so as to send an instruction, for cancelling the exchange from large denomination to small denomination process or exchange from small denomination to large denomination process, to the control unit 15, the banknotes stored in each recycling-style banknote storage unit 27 will be transported to the banknote eject opening 22 by the transport unit 25 via the discriminating unit 26, as shown in FIG. 15C.

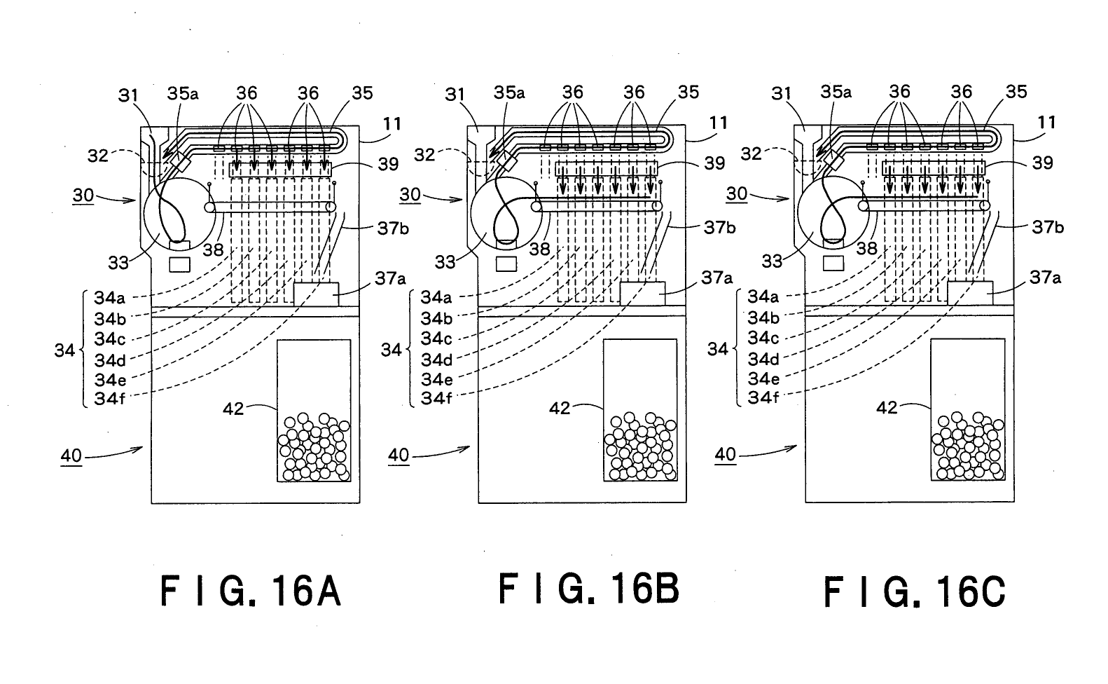

Next, the exchange from large denomination to small denomination process and exchange from small denomination to large denomination process for the coins in the coin handling apparatus 30 will be described with reference to FIGS. 16A to 16C. When an instruction for performing the exchange from large denomination to small denomination process or exchange from small denomination to large denomination process for the coins is sent to the control unit 15 by the operator via the operating unit 45, and when the operator inserts the coins into the coin insertion opening 31 of the coin handling apparatus 30, the coins inserted into the banknote insertion opening 31 will be first transferred to the coin feed-out unit 33, and then fed out to the transport unit 35, one coin for each operation, from the coin feed-out unit 33. Thereafter, the discrimination process for the coins fed to the transport unit 35 will be performed by the discriminating unit 35a. As shown in FIG. 16A, the coins discriminated as normal ones by the discriminating unit 35a are then held by the coin temporary holding unit 39 for each denomination of money. In this case, the coins held in excess for the volume of the coin temporary holding unit 39 will be transferred to the lateral transport unit 38 via the sorting hole 36 provided for overflowing (that is located on the most upstream side in the transport unit 35). Thereafter, when the coins held in the coin temporary holding unit 39 are stored in each recycling-style coin storage unit 34, the coins transferred onto the lateral transport unit 38 will be transported to the coin feed-out unit 33, and the feed-out and discrimination processes for such coins will be performed again. Subsequently, the coins will be held in the coin temporary holding unit 39, via each sorting hole 36, for each denomination of money, and then stored in each recycling-style coin storage unit 34. On the other hand, as is also shown in FIG. 16A, the coins discriminated, as unidentifiable ones or the like to be ejected, by the discriminating unit 35a, will be transported to the coin return opening 32 by the transport unit 35. During such processes for the coins as shown in FIG. 16A, the counting process for the coins is performed by the discriminating unit 35a.

After the processes as described above for the coins are performed, as shown in FIG. 16B, the coins different in the denomination of money from the coins taken into the coin handling apparatus 30, among the coins of various denominations of money stored in each recycling-style coin storage unit 34, will be transferred to the coin temporary holding unit 39, automatically, by the number of coins that corresponds to the total amount of money of the coins taken into the coin handling apparatus 30. Thereafter, such coins will be dropped onto the lateral transport unit 38 from the coin temporary holding unit 39 for each denomination of money, then transported to the coin feed-out unit 33 by the lateral transport unit 38, and finally transferred to the coin return opening 32 from the coin feed-out unit 33 via the transport unit 35. During this process, the counting process for the coins is carried out by the discriminating unit 35a. In this way, a confirmation process for checking whether or not the total amount of money of the coins taken into the coin handling apparatus 30 is the same as the total amount of money of the coins returned to the exterior from the coin handling apparatus 30 can be performed.

During such processes for the coins as described above, when the operator pushes “the cancelling key” provided in the operating unit 45 so as to send an instruction, for cancelling the exchange from large denomination to small denomination process or exchange from small denomination to large denomination process, to the control unit 15, the coins stored in each recycling-style coin storage unit 34 will be transferred to the coin temporary holding unit 39 for each denomination of money, fallen onto the lateral transport unit 38 from the coin temporary holding unit 39, then transported to the coin feed-out unit 33 by the lateral transport unit 38, and finally transported to the coin eject opening 32 from the coin feed-out unit 33 via the transport unit 35, as shown in FIG. 16C.

With respect to the aforementioned exchange from large denomination to small denomination process or exchange from small denomination to large denomination process for the banknotes or coins, it is also contemplated that the denomination of money to be obtained by the exchange from large denomination to small denomination process or exchange from small denomination to large denomination process can be optionally selected. More specifically, in the case in which the operator selects a certain denomination of money by using the operating unit 45, the money related to the selected denomination will be transferred to the banknote eject opening 22 or coin return opening 32.

### (Checking Process)

Next the checking process for the banknotes and/or coins will be described. The checking process for the banknotes means a process for counting the banknotes taken or stored in the banknote handling apparatus 20, then once disbursing the banknotes into the banknote eject opening 22 in order to check the number of sheets and amount of money of the banknotes, and finally depositing the banknotes again into the banknote handling apparatus 20. On the other hand, the checking process for the coins includes two methods, i.e., a usual checking process for counting the coins taken or stored in the coin handling apparatus 30, then once disbursing the coins into the coin return opening 32 in order to check the number and amount of money of the coins, and finally depositing them again into the coin handling apparatus 30, and an automatic checking process for first sending the coins stored in each recycling-style coin storage unit 34 onto the lateral transport unit 38, then feeding out the coins by using the coin feed-out unit 33 and transporting them by using the transport unit 35, and thereafter returning the coins to each recycling-style coin storage unit 34 from the coin temporary holding unit 39 for each denomination of money. In the checking process for the coins, the operator can select either of the former or latter method, optionally, while watching the display unit 44 and using the operating unit 45.

First, the checking process for the banknotes in the banknote handling apparatus 20 will be described with reference to FIG. 17. In the state in which the banknotes are stored in each recycling-style banknote storage unit 27 of the banknote handling apparatus 20, when an instruction for checking the banknotes is sent to the control unit 15 by the operator via the operating unit 45, all banknotes stored in each recycling-style banknote storage unit 27 will be transported to the banknote eject opening 22 by the transport unit 25 via the discriminating unit 26, as shown in FIG. 17. During such a process performed as shown in FIG. 17, the counting process for the banknotes is also performed by the discriminating unit 26. Thereafter, the banknotes transported in the banknote eject opening 22 will be checked, for the number of sheets and amount of money, by the operator, then deposited again into the banknote handling apparatus 20 via the banknote insertion opening 21, and finally stored again into each recycling-style banknote storage unit 27.

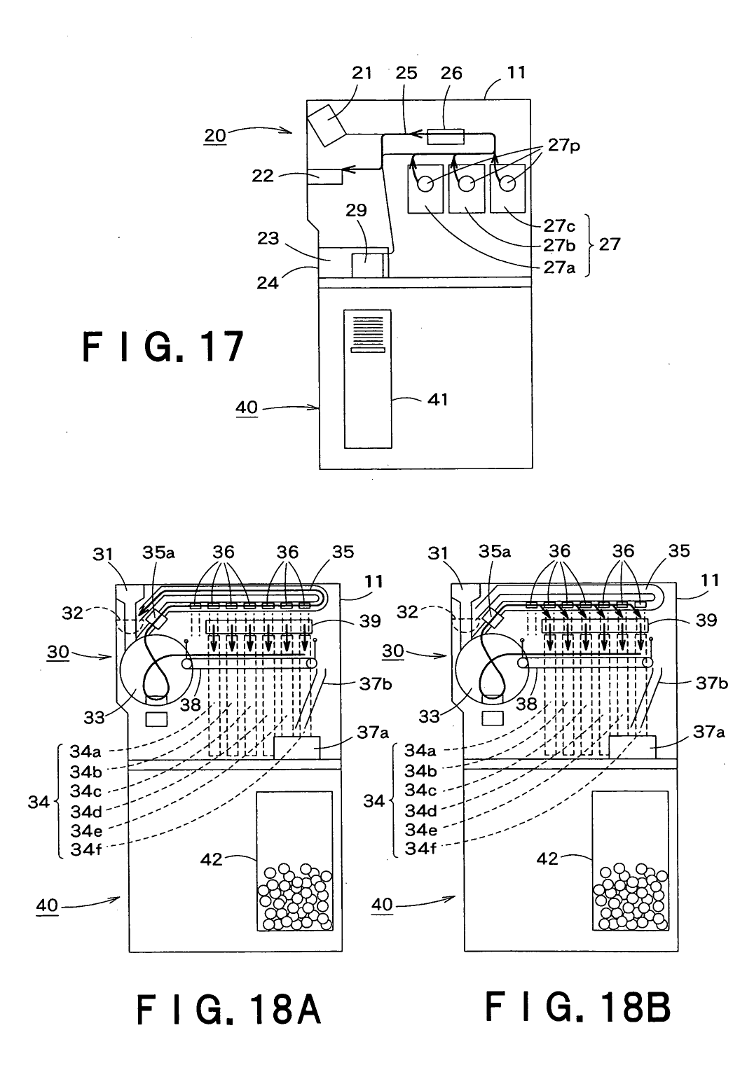

Next, the checking process for the coins in the coin handling apparatus 30 will be described with reference to FIGS. 18A and 18B. FIG. 18A shows the usual checking method, while FIG. 18B shows the automatic checking method. First, the usual checking method will be described. When an instruction for the usual checking process for the coins is sent to the control unit 15 by the operator via the operating unit 45, the coins stored in each recycling-style coin storage unit 34 are once transferred to the coin temporary holding unit 39 for each denomination of money, and then transported to the coin return opening 32, via the lateral transport unit 38, coin feed-out unit 33 and transport unit 35. During such processes for the coins as shown in FIG. 18A, the counting process for the coins is performed by the discriminating unit 35a. Thereafter, the coins transported to the coin return opening 32 will be checked, for the number and denomination of money of the coins, by the operator, and then inserted again into the coin handling apparatus 30 via the coin insertion opening 31, and finally stored into each recycling-style coin storage unit 34 from the coin temporary holding unit 39 for each denomination of money.

Next, the automatic checking method will be described. When an instruction for performing the automatic checking process for the coins is sent to the control unit 15 by the operator via the operating unit 45, as shown in FIG. 18B, the coins stored in each recycling-style coin storage unit 34 will be fed to the coin temporary holding unit 39 for each denomination of money, then transferred onto the lateral transport unit 38 from the coin temporary holding unit 39, and finally transported to the coin feed-out unit 33. Thereafter, the coins are fed out to the transport unit 35 from the feed-out unit 33, and the coins fed to the transport unit 35 are then discriminated by the discriminating unit 35a. Subsequently, the coins discriminated by the discriminating unit 35a are transferred to the coin temporary holding unit 39 for each denomination of money, via each sorting hole 36 provided in the transport unit 35, and finally stored in each recycling-style coin storage unit 34. In such a manner, in the automatic checking process for the coins as shown in FIG. 18B, the coins are circulated in the coin handling apparatus 30, while the counting process for the coins is performed by the discriminating unit 35a.

While the use of the automatic checking process has been described above as one example of the checking process for the coins in the coin handling apparatus 30, such an automatic checking process for the banknotes in the banknote handling apparatus may also be achieved, by additionally providing thereto a region for once evacuating therein the banknotes transferred from each recycling-style banknote storage unit, rather than using the construction of the banknote handling apparatus as shown FIG. 17.

### (Counting Process)

Next, the counting process for the banknotes and/or coins will be described. What is meant by the “counting process for the banknotes and/or coins” is a process for counting the amount of money of the banknotes and/or coins currently present beside the operator. Specifically, the counting process for the banknotes means a process for inserting first the banknotes into the banknote handling apparatus 20, then allowing the normal banknotes to be once held in the banknote holding unit 29 while transferring the abnormal banknotes to the banknote eject opening 22 in order to eject them to the exterior, as well as counting the banknotes during such handling. Finally, the door 24 will be automatically opened, so that the operator can take out the banknotes held in the banknote holding unit 29. On the other hand, the counting process for the coins means a process for inserting first the coins into the coin handling apparatus 30, then allowing the normal coins to be transferred to the lateral transport unit 38 through the overflowing sorting hole 36 while transporting the abnormal coins to the coin return opening 32 in order to remove such ejected coins. Thereafter, the coins transferred to the lateral transport unit 38 will be transported to the coin return opening 32, via the coin feed-out unit 33 and transport unit 35, so that the operator can take out the coins in the coin return opening 32.

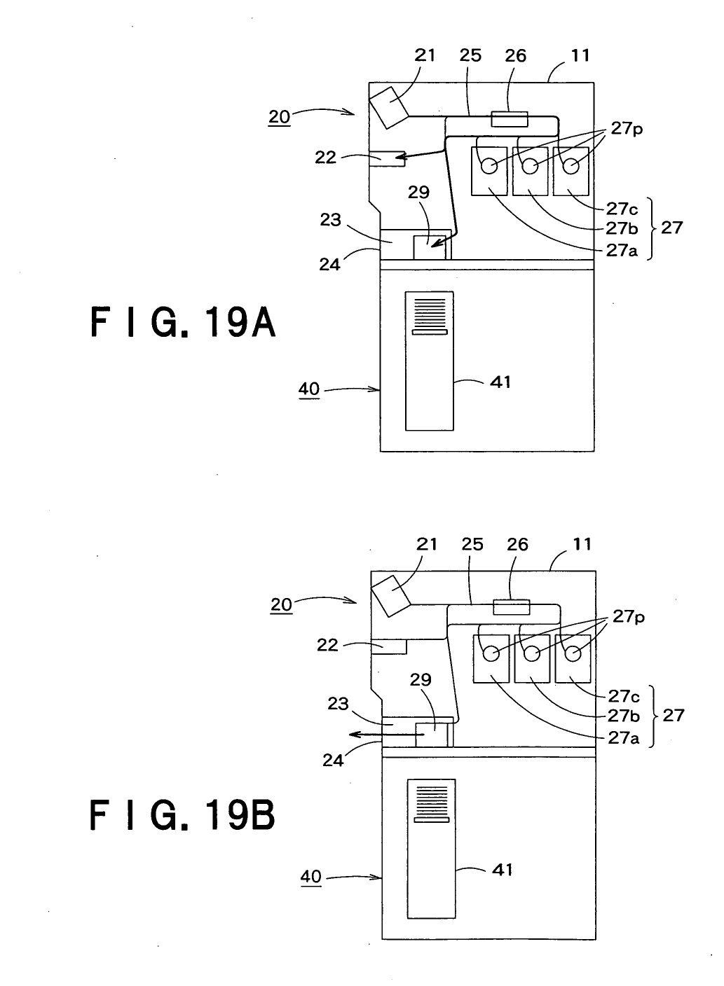

Furthermore, the counting process for the banknotes in the banknote handling apparatus 20 will be described with reference to FIGS. 19A and 19B. When an instruction for performing the counting process for the banknotes is sent to the control unit 15 by the operator via the operating unit 45, and when the operator inserts the banknotes into the banknote insertion opening 21 of the banknote handling apparatus 20, the banknotes inserted into the banknote insertion opening 21 will be transported by the transport unit 25, one sheet for each operation, and then the discrimination for the banknotes will be performed by the discriminating unit 26. As shown in FIG. 19A, in the case in which the banknotes are discriminated, as normal ones, by the discriminating unit 26, the banknotes will be transported to the banknote holding unit 29 by the transport unit 25. On the other hand, as is also shown in FIG. 19A, in the case in which the banknotes are discriminated, as damaged and/or unfit ones or the like to be ejected, by the discriminating unit 26, such banknotes will be sent to the banknote eject opening 22 by the transport unit 25. During such processes as shown in FIG. 19A, the counting process for the banknotes is performed by the discriminating unit 26.

After the process for the banknotes as described above is performed, the door 24 will be automatically opened, as such the operator can take out the banknotes held in the banknote holding unit 29, as shown in FIG. 19B.

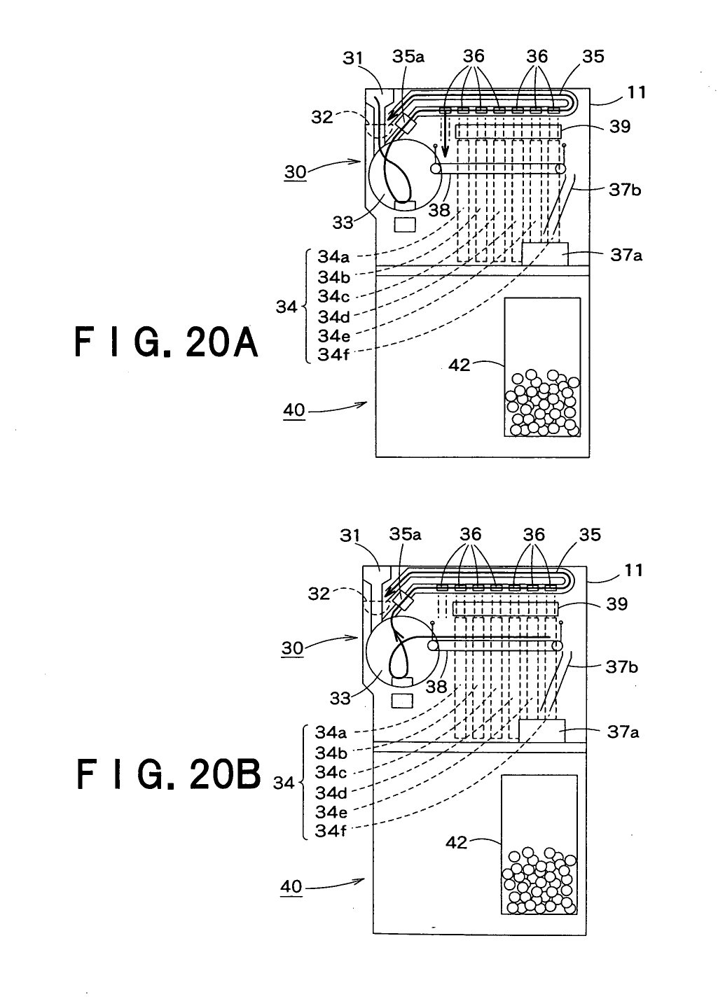

Next, the counting process for the coins in the coin handling apparatus 30 will be described with reference to FIGS. 20A and 20B. When an instruction for performing the counting process for the coins is sent to the control unit 15 by the operator via the operating unit 45, and when the operator inserts the coins into the coin insertion opening 31 of the coin handling apparatus 30, the coins inserted into the coin insertion opening 31 will be first transported to the coin feed-out unit 33, and then fed out from the coin feed-out unit 33 to the transport unit 35, one coin for each operation. Thereafter, the coins fed to the transport unit 35 are discriminated by the discriminating unit 35a. As shown in FIG. 20A, in the case in which the coins are discriminated, as normal ones, by the discriminating unit 35a, the coins will be transferred onto the lateral transport unit 38, via the sorting hole 36 provided on the most upstream side in the transport unit 35 (i.e., the sorting hole 36 for overflowing coins). On the other hand, as is also shown in FIG. 20A, the coins discriminated, as unidentifiable ones or the like to be ejected, by the discriminating unit 35a, will be transported to the coin return opening 32 by the transport unit 35. During such processes for the coins as shown in FIG. 20A, the counting process for the coins is performed by the discriminating unit 35a.

After the process as described above for the coins is performed, when the coins fed into the coin return opening 32 are removed by the operator, as shown in FIG. 20B, the coins transferred onto the lateral transport unit 38 will be first transported to the coin feed-out unit 33, and then fed out to the coin return opening 32 form the coin feed-out unit 33 via the transport unit 35. Thus, the operator can take out the coins from the coin return opening 32.

In the coin handling apparatus 30 configured as shown in FIG. 3, the coin return opening 32 serves as both of the disbursing opening and the eject opening. Therefore, the ejected coins are first transferred to the coin return opening 32, and the coins having been transferred onto the lateral transport unit 38 are then transported into the coin return opening 32 after removal of the ejected coins by the operator. However, in the case in which the disbursing opening and the eject opening for the coins are provided separately in the coin handling apparatus, the normal coins can be transported to the disbursing opening while the ejected coins are transferred to the elect opening, thereby providing a more rapid counting process for the coins.

According to the money handling machine 10 of this embodiment, for example, in the banknote handling apparatus 20, the control unit 15 is configured to selectively perform one of the following three processes: (A) the mass delivery process for transporting the banknotes inserted in the casing 11 through the banknote insertion opening 21, to the banknote holding unit 29, by using the transport unit 25, and then transferring the banknotes held in the banknote holding unit 29, into the banknote storage cassette 41 of the money storage unit 40, (B) the depositing process, in the mode with the delivery process, for depositing the money inserted in the casing 11 through the money insertion opening 21, into the money storage cassette 41 of the money storage unit 40, together with the delivery process for delivering the money stored in each recycling-style money storage unit 27, into the money storage cassette 41; and (C) the depositing process, in the mode without the delivery process, for depositing the money inserted in the casing 11 through the money insertion opening 21, into the money storage cassette 41 of the money storage unit 40, independently of the delivery process for delivering the money stored in each recycling-style money storage unit 27, into the money storage cassette 41. Therefore, plural kinds of processes can be selectively performed, in the banknote handling apparatus 20 of the money handling machine 10, due to the control provided by the control unit 15, for handing the banknotes.

In the above description with respect to the banknote handling apparatus 20 of the money handling machine 10, while the control unit 15 has been discussed as one configured to selectively perform one of the three processes: (A) the mass delivery process, (B) the depositing process in the mode with the delivery process and (C) the depositing process in the mode without the delivery process, the present invention is not limited to this aspect. For instance, in the coin handling apparatus 30 of the money handling machine 10, the control unit 15 may also be configured to selectively perform one of the three processes: (A) the mass delivery process, (B) the depositing process in the mode with the delivery process and (C) the depositing process in the mode without the delivery process, for handling the coins.

### Second Embodiment

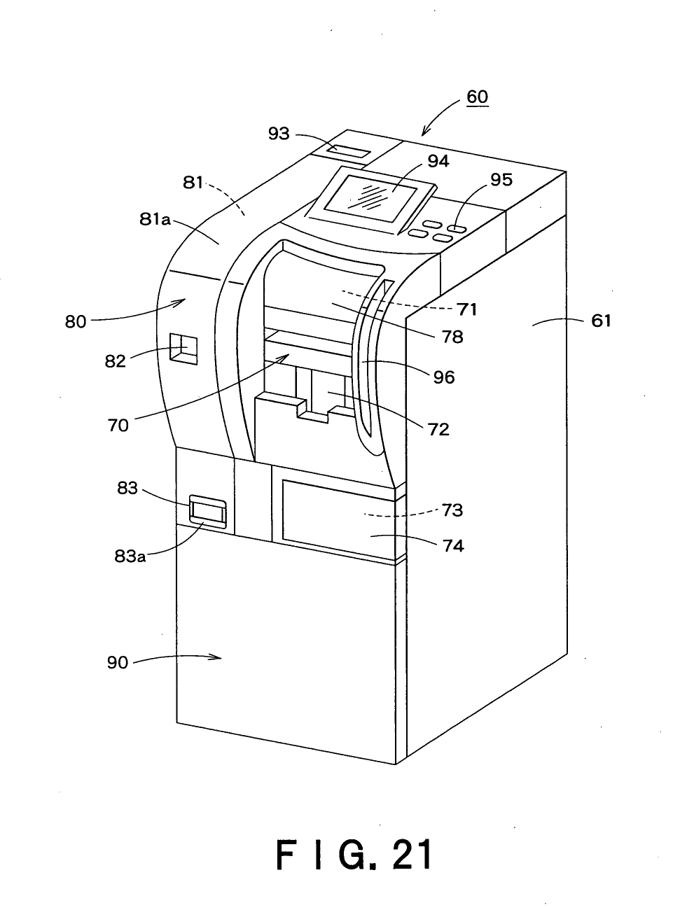

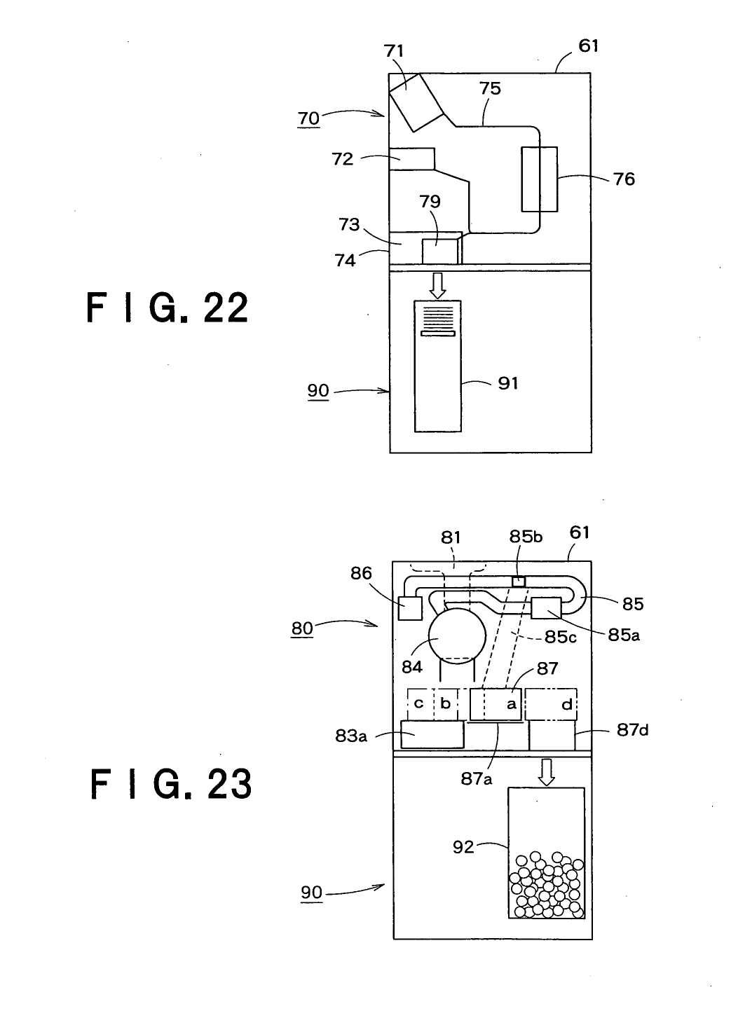

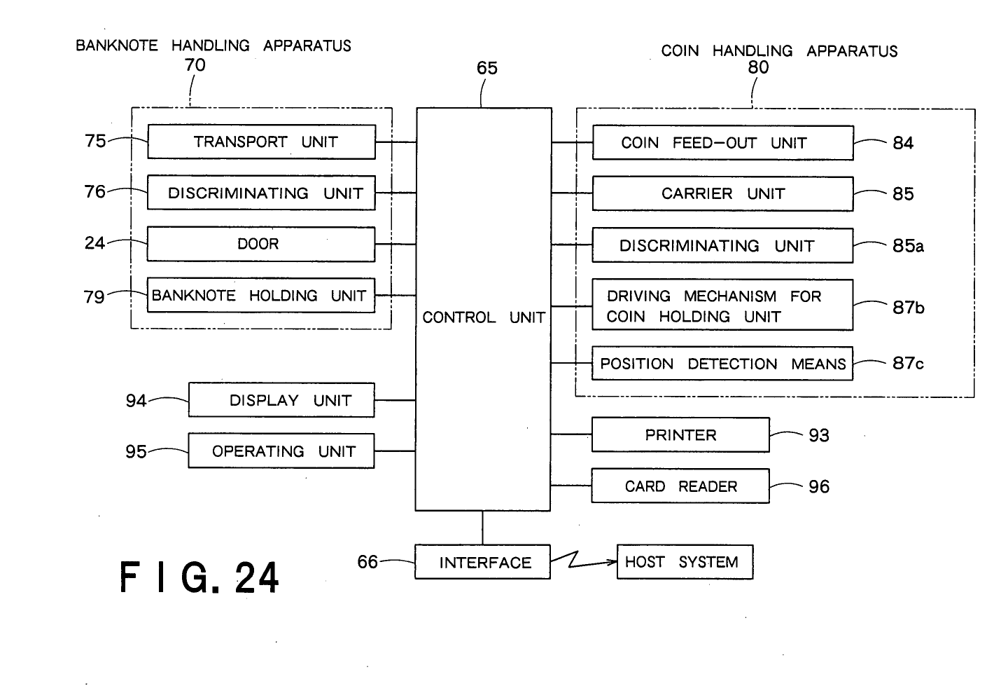

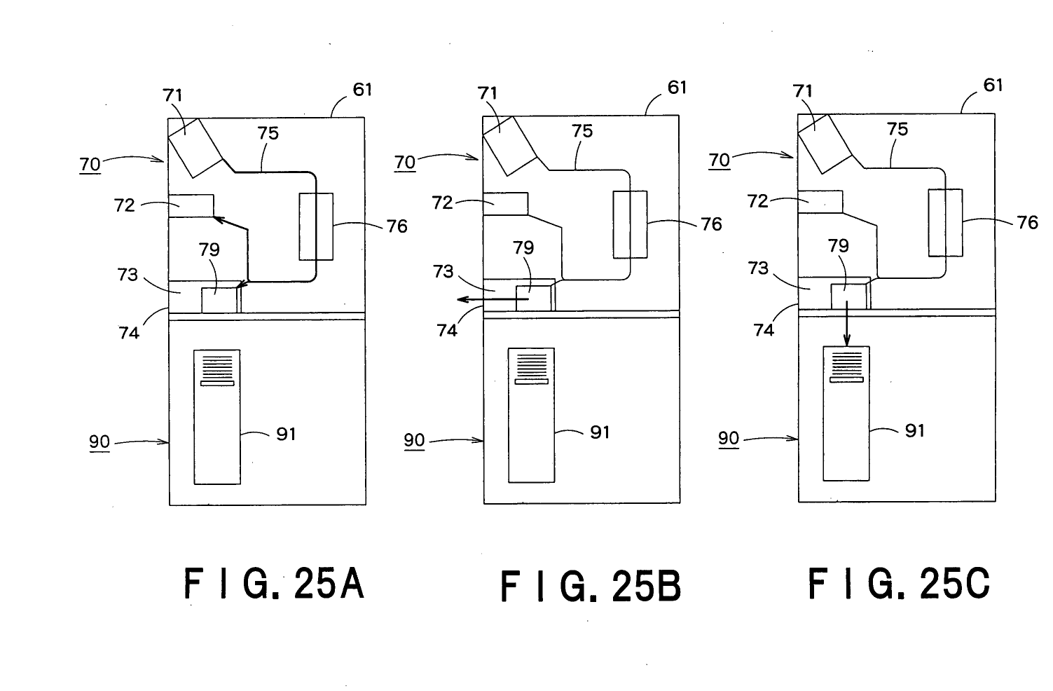

Hereinafter, the money handling machine of a second embodiment of the present invention will be described with reference to the drawings. The money handling machine related to this embodiment has functions for performing the delivery process and the counting process, for the money including coins and banknotes. FIGS. 21 to 29 respectively show the second embodiment of the money handling machine according to the present invention. Of these drawings, FIG. 21 is a perspective view showing the money handling machine of the second embodiment of the present invention, FIG. 22 is a schematic view showing general construction of the banknote handling apparatus of the money handling machine shown in FIG. 21, and FIG. 23 is a schematic view showing general construction of the coin handling apparatus of the money handling machine shown in FIG. 21. FIG. 24 is a control block diagram for the money handling machine shown in FIG. 21. FIGS. 25 to 29 are illustrations respectively showing operations for various processes in the banknote handling apparatus or coin handling apparatus of the money handling machine shown in FIG. 21.

As shown in FIG. 21, the money handling machine 60 includes a generally rectangular parallelepiped casing 61. In the casing 61, when seen in a front view, the banknote handling apparatus 70 located on the right side of the money handling machine 60 and the coin handling apparatus 80 located on the left side are provided side by side. In the casing 61 of the money handling machine 60 and below the banknote handling apparatus 70 and coin handling apparatus 80, a money storage unit 90 configured for storing therein the coins and/or banknotes is provided. Now, components of the banknote handling apparatus 70, coin handling apparatus 80 and money storage unit 90 will be detailed, respectively.

First, the construction of the banknote handling apparatus 70 will be described with reference to FIGS. 21 and 22. As shown in FIGS. 21 and 22, the banknote handling apparatus 70 includes a banknote insertion opening 71 through which the banknotes are taken into the banknote handling apparatus 70, a banknote eject opening 72 configured for ejecting unfit and/or unidentifiable banknotes and/or the like, among the banknotes taken into the banknote handling apparatus 70, and a banknote return opening 73 configured for returning the banknotes not allowed to be stored in the money storage unit 90, among those taken into the banknote handling apparatus 70, to the exterior of the banknote handling apparatus 70. In addition, as shown in FIG. 22, in the banknote handling apparatus 70, a transport unit 75 is provided, which is adapted for transporting the banknotes inserted through the banknote insertion opening 71, in the banknote handling apparatus 70.

The banknote insertion opening 71 is configured such that one sheet or multiple sheets of banknotes arranged in a bundle can be inserted through the opening, collectively, by an operator, in the transverse direction of the banknotes. As shown in FIG. 21, a banknote insertion cover 78 that can be opened and closed by hand is provided to the banknote insertion opening 71. The banknote insertion cover 78 is configured such that the operator can insert the banknotes through the banknote insertion opening 71 only when the cover 78 is opened. In addition, a banknote stage (not shown) is provided to the banknote insertion opening 71. The banknote stage is configured such that the operator cannot insert the banknotes into the banknote insertion opening 71 when the banknote stage takes an elevated position during a period of time for waiting, while the operator can insert the banknotes into the banknote insertion opening 71 when the banknote stage is lowered during a period of time for handling the banknotes. As shown in FIG. 22, the banknote insertion opening 71 is connected with the transport unit 75, so that one sheet or multiple sheets of banknotes arranged in a bundle inserted through the banknote insertion opening 71 can be transported by the transport unit 75, one sheet for each operation.

The banknote eject opening 72 is connected with the transport unit 75 as shown in FIG. 22. Thus, the banknotes discriminated to be ejected, by a discriminating unit 76 which will be described later, among the banknotes taken into the banknote handling apparatus 70 through the banknote insertion opening 71, are transferred from the transport unit 75 to the banknote eject opening 72. Thus, the operator can take out the banknotes transferred into the banknote eject opening 72. The banknote eject opening 72 can also serve as a disbursing opening for disbursing changes and the like. A cover (not shown) is provided to the banknote eject opening 72. This cover is opened during the period of time for waiting, while closed during the period of time for handling the banknotes.

As shown in FIG. 22, a banknote holding unit 79 connected with the transport unit 75 is provided to the banknote return opening 73. The banknote holding unit 79 is configured to receive the banknotes transferred thereto from the transport unit 75. The banknote return opening 73 is provided with a door 74 that can be optionally opened and closed. In the case in which the banknotes held in the banknote holding unit 79 are returned, a front wall of the banknote holding unit 79 is opened, so that the operator can take out the banknotes through the door 74. The door 74 is configured to be automatically opened when the banknotes are allowed to be taken out. As will be described later, in some cases, the banknotes held in the banknote holding unit 79 are transferred to a banknote storage cassette 91 (described later) located in the money storage unit 90, rather than taken out from the banknote return opening 73 by the operator.

The transport unit 75 has a function for transporting the banknotes, one sheet for each operation, successively, in the banknote handling apparatus 70. More specifically, in the transport unit 75, each banknote is transported along a transport route while being grasped between a pair of belts. As shown in FIG. 22, the transport route provided in the transport unit 75 is bifurcated at various points, and a bifurcating member (not shown) is provided at each point where the transport route is bifurcated. Each bifurcating member is composed of, for example, a bifurcating nail, and such bifurcating members are controlled by a control unit 65 which will be described later, respectively. Further, as shown in FIG. 22, the transport unit 75 is configured to transport the banknotes inserted through the banknote insertion opening 71, to the banknote eject opening 72 or to the banknote holding unit 79.

As shown in FIG. 22, the discriminating unit 76, adapted for discriminating the banknotes transported by the transport unit 75, one sheet for each operation, is provided with the transport unit 75. Namely, the discriminating unit 76 is adapted for discriminating each banknote transported by the transport unit 75, in regard to its denomination, unfitness, damage, etc. More specifically, the discriminating unit 76 includes a magnetic sensor and/or optical sensor, and is configured to discriminate the banknotes, one sheet for each operation, for its denomination and/or unfitness, by using such a sensor. Each result of discrimination obtained by the discriminating unit 76 will be sent to the control unit 65 which will be described below.

As described above, the banknote holding unit 79 is provided in the banknote return opening 73, and is connected with the transport unit 75 as shown in FIG. 22. To the banknote holding unit 79, the banknotes inserted through the banknote insertion opening 71 will be transported by the transport unit 75. Thus, in the banknote holding unit 79, the banknotes transferred from the transport unit 75 can be held, in a plural number, in a bundled stage. As a result, by opening the door 74, the operator can take out the banknotes stored in the banknote holding unit 79. In this case, when the banknotes are held in the banknote holding unit 79, the banknotes are temporarily placed on a temporary holding plate. In addition, when the banknotes held in the banknote holding unit 79 are stored in the banknote storage cassette 91, a stage provided in the banknote storage cassette 91 is moved to receive the banknotes placed on the temporary holding plate of the banknote holding unit 79, and then lowered from the banknote holding unit 79 into the banknote storage cassette 91 after receiving the banknotes thereon. Thereafter, the banknotes placed on the stage are pressed, from above, by a pressing member, so as to be stored in the banknote storage cassette 91.

Next, construction of the coin handling apparatus 80 will be described with reference to FIGS. 21 and 23. As shown in FIGS. 21 and 23, the coin handling apparatus 80 includes a coin insertion opening 81 configured for taking the coins into the coin handling apparatus 80, a coin eject opening 82 configured for ejecting the coins or the like unidentifiable to a discriminating unit 85a which will be described later, among the coins taken into the coin handling apparatus 80, and a coin return opening 83 configured for returning the coins not allowed to be stored in the money storage unit 90, among the coins taken into the coin handling apparatus 80, to the exterior of the coin handling apparatus 80. A coin insertion opening cover 81a configured to be optionally opened and closed is provided to the coin insertion opening 81. In addition, a coin return box 83a is provided in the coin return opening 83, such that the return box 83a can be drawn out from the coin return opening 83.

In the coin handling apparatus 80, an accumulation and feed-out unit 84 is provided, which is adapted for receiving and accumulating therein the coins inserted from the coin insertion opening 81, and then feeding them out, one coin for each operation, while opening its bottom portion for allowing deformed coins, foreign material or the like to be dropped and discharged downward. At a bottom portion of the accumulation and feed-out unit 84, an opening and closing mechanism (not shown) is provided. When the opening and closing mechanism is opened, the deformed coins, foreign material or the like present in the accumulation and feed-out unit 84 will be dropped and discharged downward.

Additionally, in the coin handling apparatus 80, a transport unit 85 is provided, which is adapted for transporting the coins fed out from the accumulation and feed-out unit 84, one coin for each operation, while discriminating each coin, in regard to its denomination, unfitness, damage, etc., by the discriminating unit 85a, thereby to transport the coins along each bifurcated transport route for each end point, based on the result of discrimination. A coin eject unit 86 adapted for returning the coins ejected from the transport unit 85 is connected to the transport unit 85. The transport unit 85 extends toward a back side of the casing 61 (i.e., in a rightward direction in FIG. 23) from its upstream end connected to the accumulation feed-out unit 84, and is then folded back upward to extend toward a front side of the casing 61 (i.e., in a leftward direction in FIG. 23), so as to be connected with the coin eject unit 86 at its downstream end.

In a middle portion of the transport unit 85 and on the downstream side relative to the discriminating unit 85a, a bifurcating member 85b is provided, which is adapted for bifurcating the transport route for the coins discriminated as normal or regular ones by the discriminating unit 85a, from the transport unit 85. Namely, the bifurcating member 85b is configured to be advanced and retracted in a transport passage of the transport unit 85 based on the result of discrimination obtained by the discriminating unit 85a, thereby bifurcating the transport route for the coins to be temporarily held in a coin holding unit 87 which will be described later, from the transport unit 85, while allowing the ejected coins to be still transported by the transport unit 85. At the point of the bifurcating member 85b, a top end of a temporary holding chute 85c is located, which is adapted for receiving and guiding downward the coins bifurcated or separated by the bifurcating member 85b. A bottom end of the temporary holding chute 85c is located above the coin holding unit 87 that is located in a temporary holding position (a) (described later).

The coin eject unit 86 is provided inside the coin eject opening 82 and is adapted for receiving the ejected coins that will be carried up to the downstream end of the transport unit 85, so that such coins can be taken out from the coin eject opening 82.

As shown in FIG. 23, in the coin handling apparatus 80, the coin holding unit 87 is provided, which is adapted for temporarily holding the coins transported by the transport unit 85. The coin holding unit 87 is formed into a frame-like shape that is opened upward and downward. The coin holding unit 87 is located below the accumulation and feed-out unit 84 in the casing 61, and is configured to be reciprocally moved forward and backward (i.e., in both of the right and left directions in FIG. 23) in the casing 61 by a driving means 87b. In addition, the coin holding unit 87 is configured to store therein the coins more than the capacity for storing the coins of the accumulation and feed-out unit 84.

Stop positions in which the coin holding unit 87 stops include four positions, i.e., the temporary holding position (a) for receiving the coins transferred from the transport unit 85 through the temporary holding chute 85c, an eject position (b) for receiving the coins dropped and discharged downward from the accumulation feed-out unit 84, a return position (c) for allowing the coins temporarily held in the coin holding unit 87 to be dropped into the coin return box 83a, and a storage position (d) for allowing the coins temporarily held in the coin holding unit 87 to be dropped into a coin storage cassette 92 (described later) of the money storage unit 90. Each stop position (a) to (d) of the coin holding unit 87 is detected by a position detection means 87c. In this case, the coin holding unit 87 is located in the temporary holding position (a) as a usual stop position.

Under the coin holding unit 87 located in the temporary holding position (a), a bottom plate 87a is provided for blocking a bottom face of the coin holding unit 87. Therefore, when the coin holding unit 87 is moved to the eject position (b) or return position (c) on the front side in the casing 61 (or left side in FIG. 23) or when the coin holding unit 87 is moved to the storage position (d) on the back side in the casing (or right side in FIG. 23), the bottom face of the coin holding unit 87 is opened because the coin holding unit 87 is moved away from the bottom plate 87a. Thus, the coins temporarily held in the coin holding unit 87 will be dropped and discharged downward.

Under the coin holding unit 87 located in the storage position (d), a coin storage chute 87d configured for transferring the coins held in the coin holding unit 87 into the coin storage cassette 92 is provided. Thus, when the coin holding unit 87 is moved from the temporary holding position (a) to the storage position (d), the coins temporarily held in the coin holding unit 87 will be fallen into the coin storage cassette 92 of the money storage unit 90 via the coin storage chute 87d.

Next, other various mechanisms provided in the money handling machine 60 will be described. As shown in FIG. 21, an operating unit 95 adapted for allowing the operator to provide various instructions to the control unit 65 (described later) of the money handling machine 60, and a display unit 94 adapted for displaying details of handling the money in the money handling machine 60 are provided on a top face of the casing 61 of the money handling machine 60. The operating unit 95 includes, for example, a numeric key pad, a confirmation key, a start key, a cancelling key and a reset key, such that the operator can provide various instructions to the control unit 65 of the money handling machine 60 by pushing these keys. The display unit 94 is composed of, for example, a liquid crystal display (LCD). In addition, on the top face of the casing 61 of the money handling machine 60, a printer 93 for printing the details of handling the money in the money handling machine 60 is provided.

Furthermore, a card reader 96 adapted for checking the operator's authority to operate the machine are provided, at a front face of the casing 61.

In addition, as shown in FIG. 21, the money storage unit 90 is provided at a lower portion of the casing 61 of the money handling machine 60. The money storage unit 90 includes the banknote storage cassette 91 for storing the banknotes therein and the coin storage cassette 92 for storing the coins therein. To the banknote storage cassette 91, the banknotes once held in the banknote holding unit 79 of the banknote handling apparatus 70 will be transferred. Meanwhile, as described above, when the coin holding unit 87 of the coin handling apparatus 80 is moved to the storage position (d), the coins once held in the coin holding unit 87 will be transferred into the coin storage cassette 92. By a certain person for collecting the money, such as by a guard of a security company entrusted with a collecting business for takings, each cassette 91, 92 of the money storage unit 90 will be drawn out forward from the casing 61. Thus, the certain person for collecting the money can collect each cassette 91, 92, itself.

Next, the control unit 65 adapted for controlling each component of the money handling machine 60 will be described with reference to FIG. 24. The control unit 65 is located in the casing 61 of the money handling machine 60.

As shown in FIG. 24, to the control unit 65, the respective components of the banknote handling apparatus 70 (e.g., the transport unit 75, discriminating unit 76, door 74, banknote holding unit 79, etc.), respective components of the coin handling apparatus 80 (e.g., the coin feed-out unit 84, transport unit 85, discriminating unit 85a, driving mechanism 87b for the coin holding unit 87, position detection means 87c for the coin holding unit 87, etc.), display unit 94, operating unit 95, printer 93, card reader 96 and the like are connected, respectively.

To the control unit 65, results of the discrimination for the banknotes due to the discriminating unit 76 of the banknote handling apparatus 70, results of the discrimination for the coins due to the discriminating unit 85a of the coin handling apparatus 80, and positional information on the coin holding unit 87 due to the position detection means 87c will be sent, respectively. In addition, information on each card that is read by the card reader 96 will be sent to the control unit 65. The control unit 65 can control the respective components of the banknote handling apparatus 70 and/or coin handling apparatus 80, as well as control the display unit 94, operating unit 95 and/or printer 93. Furthermore, the control unit 65 can communicate with a host system installed in, for example, a security company entrusted with the collecting business, via an interface 66 connected with the control unit 65.

Next, operation of the money handling machine 60 constructed as described above will be discussed.

As the operation of the money handling machine 60 as described above, there are three modes, i.e., the interface confirmation mode, operation mode and maintenance mode. The operator can select the interface confirmation mode, operation mode or maintenance mode, by using the operating unit 95.

The interface confirmation mode is a mode, in which whether or not the money handling machine 60 is in communication with the host system or the like via the interface 66 is confirmed, in an initial state of the money handling machine 60 or when the money handling machine 60 is installed. In such an interface confirmation mode, when the money handling machine 60 is in communication with the host system or the like via the interface 66, various setting data can be sent to the money handling machine 60 from the host system or the like.

The operation mode includes two options, i.e., an on-line mode in which the money handling machine 60 is in communication with the host system or the like, and an off-line mode in which the communication between the money handling machine 60 and the host system or the like is shut off. Furthermore, the on-line mode includes an opened shop mode and a closed shop mode. In the opened shop mode, the operator can carry out a delivery process, a counting process and the like, which will be described later, respectively. Additionally, in this opened shop mode, the collection of each cassette 91, 92 itself of the money storage unit 90 can be carried out, by a certain person for collecting the money, such as by a guard of a security company entrusted with the collecting business for takings. On the other hand, in the closed shop mode, only the collection of each cassette 91, 92 of the money storage unit 90 by such a certain person can be carried out. It is noted that switching between the opened shop mode and the closed shop mode may be automatically performed in accordance with a period of time or the like. In the off-line mode, communication for information to the host system or the like is not performed, and results of the depositing process and/or the like will be stored in a storage medium (not shown) provided in the money handling machine 60. The selection of each mode described above is carried out by the operator by using the operating unit 95.

In the maintenance mode, a person in charge of maintenance carries out the maintenance for each component of the banknote handling apparatus 70 and coin handling apparatus 80 of the money handling machine 60. Such maintenance may be carried out in a working site in which the money handling machine 60 is installed, or performed in a factory or the like after bringing it back thereto.

Now, each of the aforementioned delivery process and counting process will be detailed with reference to FIGS. 25 to 29.

### (Delivery Process)

Hereinafter, the delivery process for the banknotes and/or coins will be described.

First, the delivery process for the banknotes in the banknote handling apparatus 70 will be described with reference to FIGS. 25A to 25C. When an instruction for the delivery process for the banknotes is sent to the control unit 65 by the operator via the operating unit 95, and when the operator inserts the banknotes into the banknote insertion opening 71 of the banknote handling apparatus 70, the banknotes inserted into the banknote insertion opening 71 will be transported by the transport unit 75, one sheet for each operation, and then the discrimination for the banknotes will be performed by the discriminating unit 76. As shown in FIG. 25A, in the case in which the banknotes are discriminated, as normal ones, by the discriminating unit 76, the banknotes will be transported to the banknote holding unit 79 by the transport unit 75. On the other hand, as is also shown in FIG. 25A, the banknotes discriminated, as unfit ones or the like to be ejected, by the discriminating unit 76, will be transported to the banknote eject opening 72 by the transport unit 75. During such processes for the banknotes as shown in FIG. 25A, the counting process for the banknotes is performed by the discriminating unit 76.

After the processes as described above for the banknotes are performed, when the operator pushes “the cancelling key” provided in the operating unit 95 so as to send an instruction, for cancelling the delivery process, to the control unit 65, the door 74 provided at the banknote return opening 73 will be opened, thus allowing the operator to take out the banknotes from the banknote holding unit 79, as shown in FIG. 25B.

Meanwhile, after the processes as described above for the banknotes are performed, when the operator pushes “the confirmation key” provided in the operating unit 95 so as to send an instruction for confirming the delivery process, the banknotes held in the banknote holding unit 79 will be transferred into the banknote storage cassette 91 of the money storage unit 90, as shown in FIG. 25C.

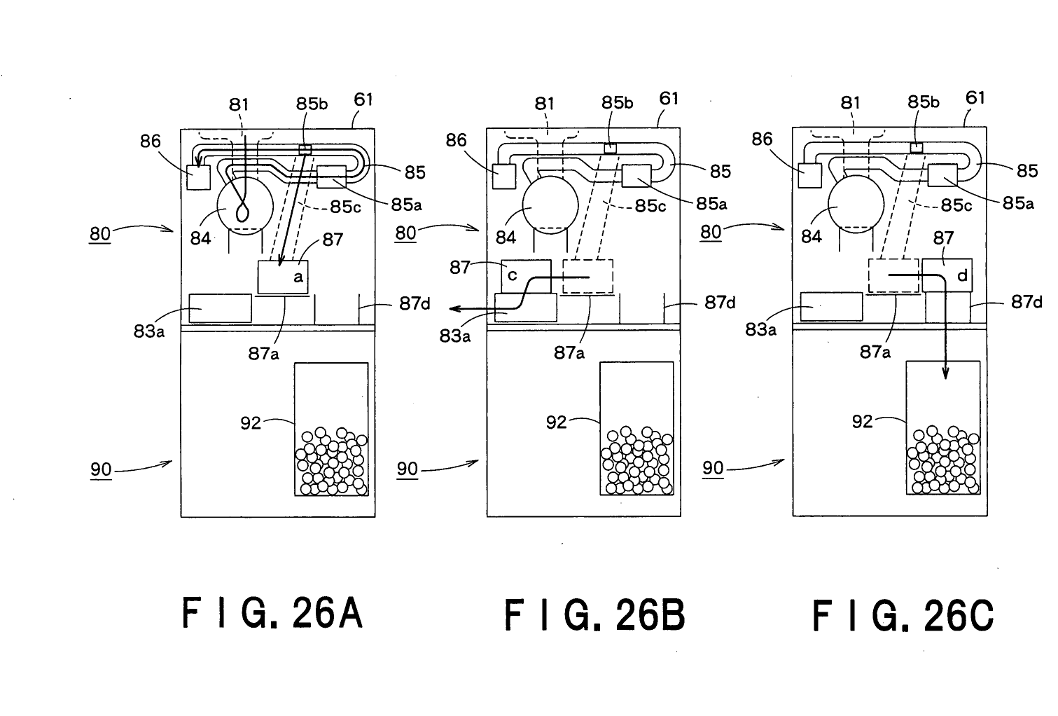

Next, the delivery process for the coins in the coin handling apparatus 80 will be described with reference to FIGS. 26A to 26C. When an instruction for the delivery process for the coins is sent to the control unit 65 by the operator via the operating unit 95, and when the operator inserts the coins into the coin insertion opening 81 of the coin handling apparatus 80, the coins inserted into the coin insertion opening 81 will be first transported to the accumulation and feed-out unit 84, and then fed out from the accumulation and feed-out unit 84 to the transport unit 85, one coin for each operation. At this time, the coin holding unit 87 is located in the temporary holding position (a). Thereafter, the discrimination for the coins fed to the transport unit 85 will be performed by the discriminating unit 85a. As shown in FIG. 26A, in the case in which the coins are discriminated, as normal ones, by the discriminating unit 85a, the coins will be transported along the transport route bifurcated by the bifurcating member 85b from the transport passage of the transport unit 85, then transferred to the coin holding unit 87 via the temporary holding chute 85c, so as to be temporarily held in the coin holding unit 87. On the other hand, as is also shown in FIG. 26A, the coins discriminated, as unidentifiable ones or the like to be ejected, by the discriminating unit 85a will be directly transferred to the coin eject unit 86, without being transported along the route bifurcated from the transport passage of the transport unit 85. During such processes for the coins as shown in FIG. 26A, the counting process for the coins is performed by the discriminating unit 85a.

After the processes as described above for the coins are performed, when the operator pushes “the cancelling key” provided in the operating unit 95 so as to send an instruction, for cancelling the delivery process, to the control unit 65, the coin holding unit 87 will be moved to the return position (c) from the temporary holding position (a) due to the driving mechanism 87b, as shown in FIG. 26B. Thus, the coins temporarily held in the coin holding unit 87 will be dropped into the coin return box 83a. As such, the operator can take out the coins present in the coin return box 83a by drawing out the coin return box 83a from the coin return opening 83.

Meanwhile, after the processes as described above for the coins are performed, when the operator pushes “the confirmation key” provided in the operating unit 95, so as to send an instruction, for confirming the delivery process, to the control unit 65, the coin holding unit 87 will be moved to the coin storage position (d) from the temporary holding position (a) by the driving mechanism 87b, as shown in FIG. 26C. Thus, the coins temporarily held in the coin holding unit 87 will be dropped into and stored in the coin storage cassette 92 of the money storage unit 90.

### (Counting Process)

Next, the counting process for the banknotes and/or coins will be described. What is meant by the “counting process for the banknotes and/or coins” is the process for counting the amount of money of the banknotes and/or coins currently present beside the operator. Specifically, the counting process for the banknotes means a process for inserting first the banknotes into the banknote handling apparatus 70, then allowing the normal banknotes to be once held in the banknote holding unit 79 while transferring the abnormal banknotes to the banknote eject opening 72 in order to eject them to the exterior, as well as counting the banknotes during such handling. Finally, the door 74 will be automatically opened, so that the operator can take out the banknotes held in the banknote holding unit 79. On the other hand, the counting process for the coins means a process for inserting first the coins into the coin handling apparatus 80, then allowing the normal coins to be transferred to the coin holding unit 87 while transporting the abnormal coins to the coin reject unit 86 in order to remove such ejected coins. Thereafter, the coins transferred to the coin holding unit 87 will be transported to the coin return box 83a, so that the operator can take out the coins from the coin return box 83a.

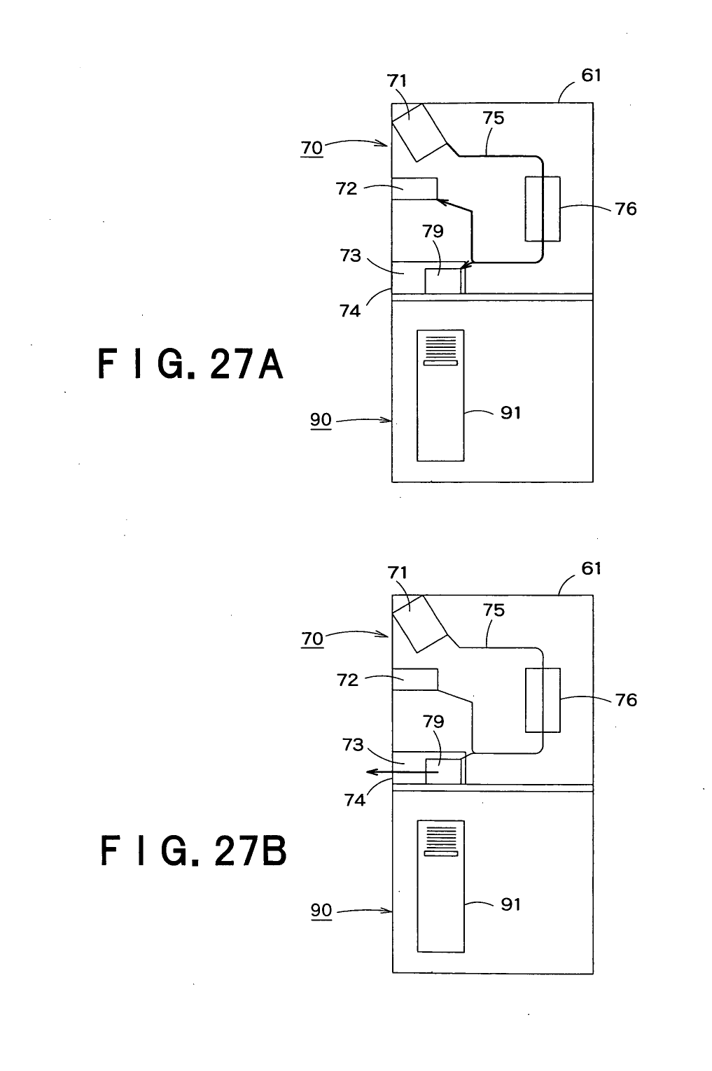

More specifically, the counting process for the banknotes in the banknote handling apparatus 70 will be described with reference to FIGS. 27A and 27B. When an instruction for performing the counting process for the banknotes is sent to the control unit 65 by the operator via the operating unit 95, and when the operator inserts the banknotes into the banknote insertion opening 71 of the banknote handling apparatus 70, the banknotes inserted into the banknote insertion opening 71 will be transported by the transport unit 75, one sheet for each operation, and then the discrimination for the banknotes will be performed by the discriminating unit 76. As shown in FIG. 27A, in the case in which the banknotes are discriminated, as normal ones, by the discriminating unit 76, the banknotes will be transported to the banknote holding unit 79 by the transport unit 75. On the other hand, as is also shown in FIG. 27A, the banknotes discriminated, as unfit ones or the like to be ejected, by the discriminating unit 76 will be transported to the banknote eject opening 72 by the transport unit 75. During such processes as shown in FIG. 27A, the counting process for the banknotes is performed by the discriminating unit 76.

After the process for the banknotes as described above is performed, the door 74 is automatically opened, as such the operator can take out the banknotes held in the banknote holding unit 79, as shown in FIG. 27B.

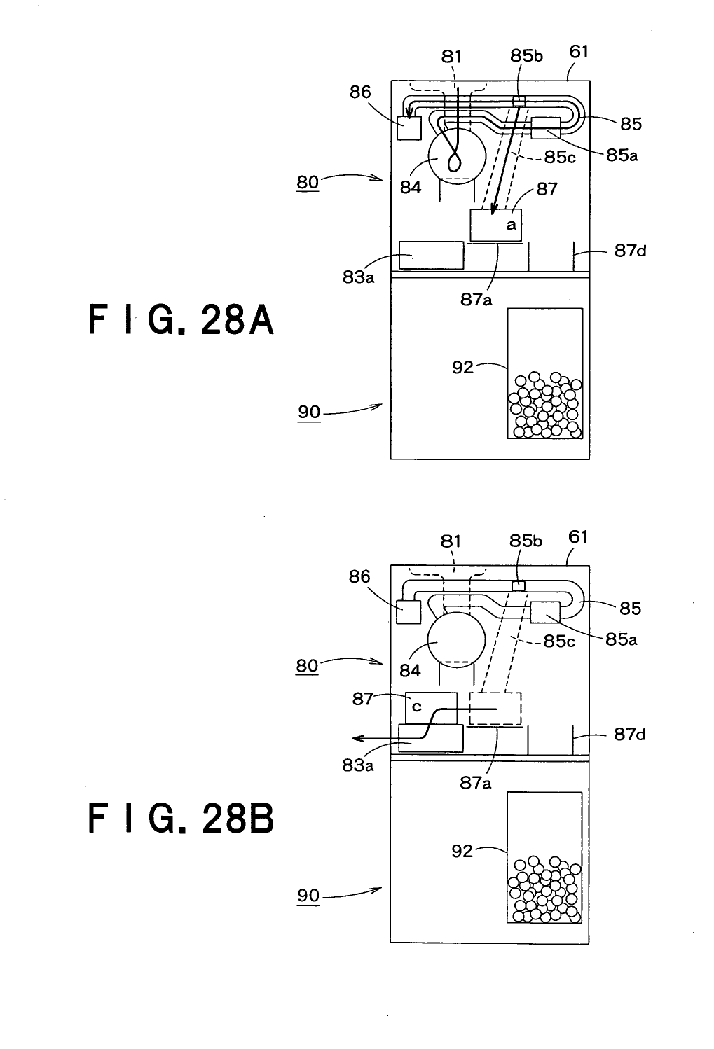

Next, the counting process for the coins in the coin handling apparatus 80 will be described with reference to FIGS. 28A and 28B. When an instruction for performing the counting process for the coins is sent to the control unit 65 by the operator via the operating unit 95, and when the operator inserts the coins into the coin insertion opening 81 of the coin handling apparatus 80, the coins inserted into the coin insertion opening 81 will be first transported to the coin accumulation and feed-out unit 84, and then fed out from the coin accumulation feed-out unit 84 to the transport unit 85, one coin for each operation. At this time, the coin holding unit 87 is located in the temporary holding position (a). Meanwhile, the coins fed out to the transport unit 85 are discriminated by the discriminating unit 85a. As shown in FIG. 28A, in the case in which the coins are discriminated, as normal ones, by the discriminating unit 85a, the coins will be transported along the transport route that is bifurcated from the transport passage of the transport unit 85, due to the bifurcating unit 85b, and then transferred to the coin holding unit 87 through the temporary holding chute 85c, so as to be temporarily held in the coin holding unit 87. On the other hand, as is also shown in FIG. 28A, the coins discriminated, as unidentifiable ones or the like to be ejected, by the discriminating unit 85a will be directly transferred to the coin eject unit 86, without being transported along the transport route bifurcated from the transport passage of the transport unit 85. During such processes for the coins as shown in FIG. 28A, the counting process for the coins is performed by the discriminating unit 85a.

After the process as described above for the coins is performed, when the coin holding unit 87 is moved to the return position (c) from the temporary holding position (a) by the driving mechanism 87b, the coins temporarily held in the coin holding unit 87 will be dropped down into the coin return box 83a. Thus, the operator can take out the coins from the coin return box 83a, by drawing out the coin return box 83a from the coin return opening 83.

### (Foreign Material Returning Process)

Next, the foreign material returning process in the coin handling apparatus 80 will be described. What is meant by the “foreign material returning process” is a process for discharging foreign material to the exterior of the coin handling apparatus 80, wherein the foreign material has been transported into the accumulation and feed-out unit 84 from the coin insertion opening 81 when deformed coins and/or foreign material (hereinafter, collectively referred to as the foreign material) has been taken into the coin handling apparatus 80.

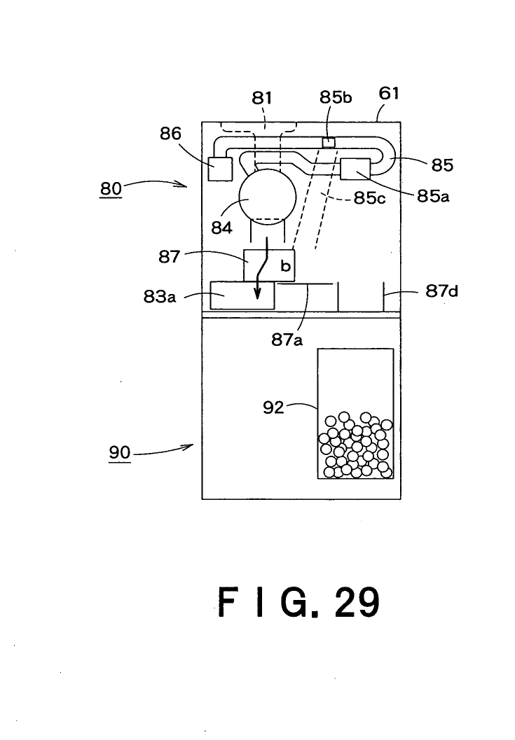

The foreign material returning process for the coins in the coin handling apparatus 80 will be described with reference to FIG. 29. In the accumulation and feed-out unit 84, a foreign material detection sensor for detecting the foreign material present in the accumulation and feed-out unit 84 is provided. The foreign material detection sensor may be a transmission-type optical sensor adapted for detecting the presence of foreign material as an object that blocks the light. When a residue of the foreign material in the accumulation and feed-out unit 84 is detected by such a foreign material detection sensor, whether or not the coins are present in the coin holding unit 87 is first checked. As a result, if the coins are present in the coin holding unit 87, a request for an instruction, for storing or returning the coins held in the coin holding unit 87, will be indicated to the operator, via a display provided on the display unit 94. Thereafter, when the coins are eliminated from the coin holding unit 87 due to the storage or returning process for the coins temporarily held in the coin holding unit 87, the coin holding unit 87 will be moved to the eject position (b) by the driving mechanism 87b, as shown in FIG. 29. Subsequently, when the opening and closing mechanism provided under the accumulation and feed-out unit 84 is opened, the foreign material will be dropped downward from the accumulation and feed-out unit 84, so as to be transferred into the coin holding unit 87. Thereafter, when the coin holding unit 87 is moved from the eject position (b) to the return position (c) by the driving mechanism 87b, the foreign material temporarily held in the coin holding unit 87 will be dropped into the coin return box 83a. Consequently, the operator can take out the foreign material from the coin return box 83a, by drawing out the coin return box 83a from the coin return opening 83.

According to the money handling machine 60 of this embodiment, for example, in the banknote handling apparatus 70, the control unit 65 is configured to selectively perform one of the two processes, i.e., (A) the delivery process for allowing the banknotes inserted in the casing 61 through the banknote insertion opening 71 to be once held in the banknote holding unit 79, and then delivering the banknotes held in the banknote holding unit 79 into the banknote storage cassette 91 of the money storage unit 90, and (B) the counting process for counting the banknotes inserted in the casing 61 through the banknote insertion opening 71, by using the discriminating unit 76, and then returning the counted banknotes to the exterior of the casing 61. Similarly, in the coin handling apparatus 80 of the money handling machine 60, the control unit 65 is configured to selectively perform one of the two processes, i.e., (A) the delivery process and (B) the counting process. Therefore, in the banknote handling apparatus 70 or coin handling apparatus 80 of the money handling machine 60, plural kinds of processes can be selectively performed, due to the control provided by the control unit 65, upon handling the banknotes or coins.

In the coin handling apparatus 80 of the money handling machine 60 as described above, when malfunction occurs upon the feed-out operation for the coins from the accumulation and feed-out unit 84, one of the following two processes may be selectively performed, with respect to the coins temporarily held in the coin holding unit 87, irrespectively of the number of coins. Namely, when the malfunction occurs upon the feed-out operation for the coins from the accumulation and feed-out unit 84, a process for allowing the coins held in the coin holding unit 87 to be dropped into the coin storage cassette 92 of the money storage unit 90 by moving the coin holding unit 87 to the storage position (d) and a process for allowing the coins held in the coin holding unit 87 to be dropped into the coin return box 83a by moving the coin holding unit 87 to the return position (c), thereby returning the coins to the exterior of the casing 61, may be selectively performed. Such selection can be performed in the maintenance mode by the operator when an instruction for the selection is sent to the control unit 65 via the operating unit 95.

In the conventional coin handling apparatus, all of the coins temporarily held in the coin holding unit should be returned to the exterior of the casing when some malfunction occurs upon the feed-out operation for the coins from the accumulation and feed-out unit. Therefore, the counting process for the coins temporarily held in the coin holding unit should be performed twice by the discriminating unit, thus making the time required for the delivery process and the like unduly long. However, with the coin handling apparatus 80 that can selectively perform the process for allowing the coins temporarily held in the coin holding unit 87 to be dropped into the coin storage cassette 92 of the money storage unit 90 and the process for returning the coins temporarily held in the coin holding unit 87 to the exterior of the casing 61, there is no need to return the coins already held in the coin holding unit 87 to the exterior of the casing 61. Accordingly, such undue increase of the handling time as seen in the conventional coin handling apparatus can be suppressed, even in the case in which the malfunction occurs upon the feed-out operation for the coins from the accumulation and feed-out unit 84 during the delivery process or the like.

1. A money handling machine adapted for handling money, comprising:
a casing;
a money storage unit provided in the casing and configured for storing the money therein;
a money insertion opening configured for inserting the money into the casing;
a transport unit provided in the casing and adapted for transporting the money inserted in the casing through the money insertion opening;
a discriminating unit provided with the transport unit and adapted for discriminating the money transported by the transport unit;
a money return opening connected with the transport unit and configured for returning the money transferred from the transport unit, to the exterior of the casing;
recycling-style money storage units provided in the casing, in a plural number, corresponding to each denomination of money, each recycling-style money storage unit being connected with the transport unit as well as configured for allowing the money, corresponding to each denomination of money, to be stored therein and fed out therefrom;
a money holding unit connected with the transport unit and adapted for temporarily holding the money that will be stored in the money storage unit; and
a control unit adapted for controlling the transport unit, recycling-style money storage units and money holding unit, respectively;
wherein the control unit is configured to selectively perform one of the following three processes:
(A) a mass delivery process for transporting the money inserted in the casing through the money insertion opening, to the money holding unit, by using the transport unit, and then transferring the money held in the money holding unit, into the money storage unit;
(B) a process, in a mode with a delivery process, for performing a depositing process for depositing the money inserted in the casing through the money insertion opening, into the money storage unit, together with the delivery process for delivering the money stored in each recycling-style money storage unit, into the money storage unit; and
(C) a process, in a mode without the delivery process, for performing the depositing process for depositing the money inserted in the casing through the money insertion opening, into the money storage unit, independently of the delivery process for delivering the money stored in each recycling-style money storage unit, into the money storage unit.

2. A money handling machine adapted for handling money, comprising:
a casing;
a money storage unit provided in the casing and configured for storing the money therein;
a money insertion opening configured for inserting the money into the casing;
a transport unit provided in the casing and adapted for transporting the money inserted in the casing through the money insertion opening;
a discriminating unit provided with the transport unit and adapted for discriminating the money transported by the transport unit;
a money return opening connected with the transport unit and configured for returning the money transferred from the transport unit, to the exterior of the casing;
a money holding unit connected with the transport unit and configured for transferring the money transferred from the transport unit, to the money storage unit; and
a control unit adapted for controlling the transport unit and money holding unit;
wherein the control unit is configured to selectively perform one of the following two processes:
(A) a delivery process for allowing the money inserted in the casing through the money insertion opening to be once held in the money holding unit, and then delivering the money held in the money holding unit, into the money storage unit; and
(B) a counting process for counting the money inserted in the casing through the money insertion opening, by using the discriminating unit, and then returning the counted money to the exterior of the casing.
